(19) United States
(12) Patent Application Publication
(10) Pub. No.: US 2006/0184825 A1
(43) Pub. Date: Aug. 17, 2006

(54) Reliability centered maintenance system and method

(76) Inventor: Nancy Regan, Madison, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/241,553

(22) Filed: Oct. 1, 2005

Related U.S. Application Data
(60) Provisional application No. 60/615,058, filed on Oct. 1, 2004.

(51) Int. Cl. G06F 11/00

(52) U.S. Cl. 714/23

(57) ABSTRACT

A reliability centered maintenance system having an input device and logic that receives and stores data indicative of a function, a functional failure, a failure mode, and a failure effect, via the input device, displays the received data to a display device in response to a first user input, and displays a plurality of logical selectable input boxes corresponding to a type of the failure mode and at least one task or default strategy for addressing the failure mode. The logic further receives at least one selection input via the selectable input boxes and receive data describing the at least one task or the at least one default strategy.

### BACKGROUND

Reliability centered maintenance (RCM) refers to a scheduling approach for maintaining equipment, for example, airplane equipment, manufacturing equipment, or other vehicle equipment. The RCM is a zero-based, structured process used to identify the failure management strategies required to ensure an asset meets its minimum requirements in its operational environment in the most safe and cost effective manner.

The conventional RCM system is based upon the principal that maintenance cannot improve the safety and reliability inherent in the design of the equipment, but such inherent characteristics may be preserved through maintenance tasks and default strategies. Further, the RCM principles described herein have resulted in the creation of a logical decision-making process that may be employed in particular industries to effectuate such principles. Such a process is hereinafter referred to as an “RCM process.”

Typically, an RCM process comprises a logical decision-making process that is designed to evaluate and construct maintenance tasks and/or default strategies for maintaining equipment and/or vehicles based upon a particular piece of equipment's functions, functional failures, and corresponding failure modes, failure effects, and consequences of the failure modes.

In evaluating equipment using an RCM process, oftentimes an individual or an industry team comprising a plurality of experts in a field with experience in and knowledge of the equipment that is to be evaluated assembles. A facilitator typically pre-defines the scope of the analysis prior to the gathering. An exemplary scope of analysis is a hydraulic system of an aircraft. Note that the facilitator oftentimes is an individual who is well-versed in the RCM process, and he/she does not necessarily have expert knowledge and/or skills related to the scope of the analysis. However, such individual may have appropriate technical background such that the individual is capable of understanding basic terminology and concepts related by the RCM team.

The RCM team begins the RCM process by identifying functions corresponding to the scope of the analysis. For example, if the scope of the analysis pertains to the hydraulic system of an aircraft, then the RCM team may identify a function, such as, for example, “to contain hydraulic fluid.” Furthermore, the team identifies failure modes corresponding to the functions identified. Once the RCM team identifies functional failures and failure modes, it identifies failure effects corresponding to the failure modes. Thereafter, the team assesses consequences of the failure modes and effects and investigates whether to assign tasks and/or default strategies for managing the failure mode identified by the RCM team.

### SUMMARY

A reliability centered maintenance system in accordance with an exemplary embodiment of the present disclosure comprises an input device and logic configured to receive and store data indicative of a function, a functional failure, a failure mode, and a failure effect, via the input device. The logic is further configured to display the received data to a display device in response to a first user input and display a plurality of logical selectable input boxes corresponding to a type of the failure mode and at least one task or default strategy for addressing the failure mode and receive at least one selection input via the selectable input boxes and receive data describing the at least one task or the at least one default strategy.

A method in accordance with an exemplary embodiment of the present disclosure comprises receiving data indicative of a function, a functional failure, a failure mode, and a failure effect and storing the data in memory. The method further comprises displaying the data received in the receiving step to a display device in response to a first user input and displaying a plurality of logical selectable input boxes corresponding to a type of the failure mode. The method further comprises receiving data indicative of at least one task for addressing the failure mode, receiving at least one selection input via the selectable input boxes, receiving data describing the at least one task, and storing in memory data indicative of the at least one task, the failure mode type, and the selection input for the failure mode.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating a reliability centered maintenance (RCM) group assembly in accordance with an exemplary embodiment of the present disclosure.

FIG. 2 is a block diagram illustrating the RCM system of FIG. 1.

FIG. 3 is a flowchart illustrating an exemplary RCM process of the present disclosure performed using the RCM system of FIG. 2.

FIG. 4A illustrates an exemplary RCM Main Menu GUI of the RCM System of FIG. 2.

FIG. 4B depicts an exemplary RCM operating context graphical user interface (GUI) of the RCM system of FIG. 2.

FIG. 5 depicts an exemplary Information Worksheet GUI of the RCM system of FIG. 2.

FIG. 6 depicts an exemplary Failure Mode Overview GUI of the RCM system of FIG. 2.

FIG. 7 is a flowchart illustrating an exemplary RCM process performed by the RCM system of FIG. 2.

FIG. 8 is a flowchart illustrating an exemplary analysis of evident failure modes that have safety/environmental consequences performed by the RCM system of FIG. 2.

FIG. 9 is a flowchart illustrating an exemplary on-condition task analysis for evident or hidden failure modes that have safety/environmental consequences performed by the RCM system of FIG. 2.

FIG. 10 is a flowchart illustrating an exemplary restoration task analysis for evident or hidden failure modes that have safety/environmental consequences performed by the RCM system of FIG. 2.

FIG. 11 is a flowchart illustrating an exemplary replacement task analysis for evident or hidden failure modes that have safety/environmental consequences performed by the RCM system of FIG. 2.

FIG. 12 is a flowchart illustrating an exemplary combination-of-tasks analysis for evident or hidden failure modes that have safety/environmental consequences performed by the RCM system of FIG. 2.

FIG. 13 is a flowchart illustrating an exemplary default operational check analysis for evident failure modes that have safety/environmental consequences performed by the RCM system of FIG. 2.

FIG. 14 is a flowchart illustrating an exemplary analysis performed on evident failure modes that have operational consequences using the RCM system of FIG. 2.

FIG. 15 is a flowchart illustrating an exemplary on-condition task analysis for evident or hidden failure modes that have operational consequences performed using the RCM system of FIG. 2.

FIG. 16 is a flowchart illustrating an exemplary restoration task analysis for evident or hidden failure modes that have operational consequences performed using the RCM system of FIG. 2.

FIG. 17 is a flowchart illustrating an exemplary replacement task analysis for evident or hidden failure modes that have operational consequences performed using the RCM system of FIG. 2.

FIG. 18 is a flowchart illustrating an exemplary combination of tasks analysis for evident failure modes that have operational consequences performed using the RCM system of FIG. 2.

FIG. 19 is a flowchart illustrating an exemplary operational check analysis for evident failure modes that have operational consequences performed using the RCM system of FIG. 2.

FIG. 20 is a flowchart illustrating an exemplary analysis of evident failure modes that have non-operational consequences performed by the RCM system of FIG. 2.

FIG. 21 is a flowchart illustrating an exemplary on-condition task analysis for evident or hidden failure modes that have non-operational consequences performed by the RCM system of FIG. 2.

FIG. 22 is a flowchart illustrating an exemplary restoration task analysis for evident failure modes that have non-operational consequences performed by the RCM system of FIG. 2.

FIG. 23 is a flowchart illustrating an exemplary replacement task analysis for evident failure modes that have non-operational consequences performed by the RCM system of FIG. 2.

FIG. 24 is a flowchart illustrating an exemplary combination of tasks analysis for evident failure modes that have non-operational consequences performed by the RCM system of FIG. 2.

FIG. 25 is a flowchart illustrating an exemplary operational check analysis for evident failure modes that have non-operational consequences performed by the RCM system of FIG. 2.

FIG. 26 is a flowchart illustrating an exemplary analysis of hidden failure modes that have safety/environmental consequences performed for by the RCM system of FIG. 2.

FIG. 27 is a flowchart illustrating an exemplary failure finding task analysis for hidden failure modes with safety/environmental consequences by the RCM system of FIG. 2.

FIG. 28 is a flowchart illustrating an exemplary analysis of hidden failure modes that have operational consequences performed by the RCM system of FIG. 2.

FIG. 29 is a flowchart illustrating an exemplary failure finding task analysis of hidden failure modes with operational or non-operational consequences performed by the RCM system of FIG. 2.

FIG. 30 is a flowchart illustrating an exemplary analysis of hidden failure modes that have non-operational consequences by the RCM system of FIG. 2.

FIG. 31 is a depiction of an exemplary area inspection analysis GUI of the RCM system of FIG. 2.

### DETAILED DESCRIPTION

Embodiments of the present disclosure generally pertain to reliability centered maintenance (RCM) systems and methods. Specifically, a system in accordance with an embodiment of the present disclosure provides an RCM graphical user interface (GUI), an RCM database, and corresponding RCM logic for. effectuating an RCM process, hereinafter referred to as “RCM system.”

The RCM GUI captures data provided by a plurality of team members, hereinafter referred to as an “RCM team,” corresponding to a technical scope of work.

The RCM system stores the captured data, and the RCM team uses the captured data in an analysis to determine suggested maintenance scheduling and/or default strategies for managing the consequences of failure modes identified, hereinafter referred to as an “RCM analysis.” Particularly, the RCM system is utilized to identify technically appropriate failure management strategies corresponding to failure modes identified in the RCM analysis. Such strategies include on-condition maintenance, scheduled restorations, scheduled replacements, scheduled discards, and default strategies.

Note that on-condition maintenance is a term that refers to a maintenance task wherein maintenance is performed “on the condition” that it needs it. For example, in the aerospace field, a maintenance person may perform a vibration test that monitors a bearing in an airplane to determine if its vibration levels have increased above an acceptable threshold. As another example, a maintenance person may inspect brake pads of a vehicle, for example in a fleet of Army all-terrain vehicles, and if the brake pads are worn to a prescribed limit, maintenance is performed on the brake pads.

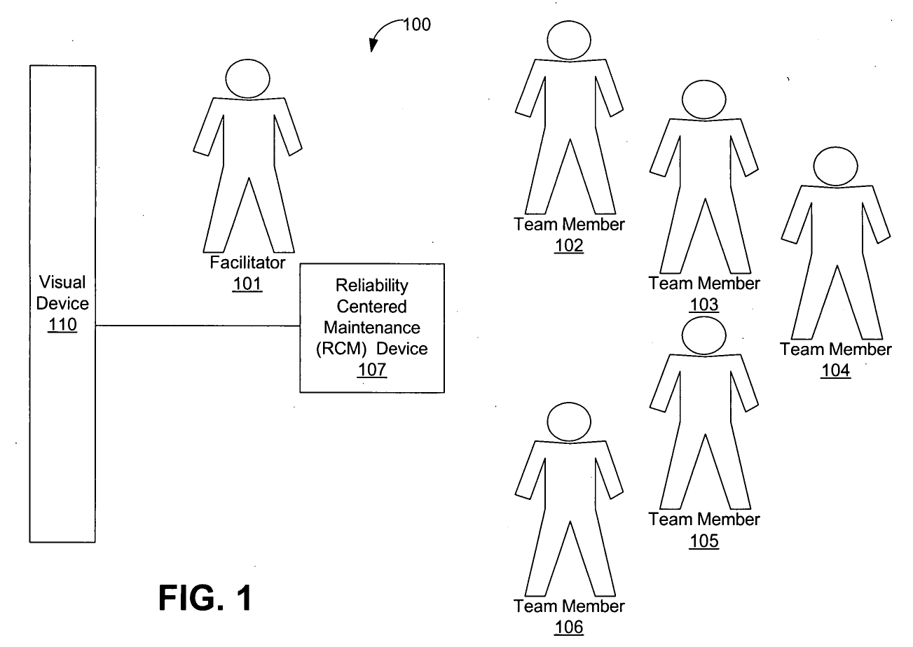

FIG. 1 illustrates a reliability centered maintenance (RCM) system 100 in accordance with an exemplary embodiment of the present disclosure. The RCM system 100 comprises an RCM device 107 and a visual device 110.

In one embodiment, the RCM device 107 is a computing device, e.g., a personal computer or a laptop computer. Furthermore, the visual device 110 is preferably a projection screen, which is described further herein.

A facilitator 101 controls the Reliability centered maintenance (RCM) system 100. The facilitator 101 requests data corresponding to the scope of a particular RCM analysis, which is described in more detail hereafter, and an RCM team comprising a plurality of team members 102-106 preferably communicates data corresponding to the requests of the facilitator 101. The number of team members 102-106 is merely an exemplary number and other numbers of team members are possible in other embodiments.

As the facilitator 101 queries the RCM team members 102-106, the team members 102-106 provide information corresponding to the queries of the facilitator 101. The facilitator 101 enters data corresponding to such information provided from the team members 102-106 into the RCM device 107. Furthermore, as the facilitator 101 enters the data into the RCM system 100, the RCM device 107 communicates the entered data to the visual device 110. Such process is described in more detail hereafter. The facilitator 101 and the team members 102-106 are hereinafter referred to as the “RCM team.”

The facilitator 101 is an individual knowledgeable and well versed in the RCM process. However, the facilitator 101 may not be knowledgeable in the technical scope of the area that is being analyzed by the RCM team.

The team members 102-106 comprise a group of individuals who are experts in a particular technical area that has been selected for an RCM analysis. For example, if the scope of the analysis pertains to the aerospace industry, the team members 102-106 may comprise a system engineer, a mechanic, a maintenance person, a person responsible for technical publications, a maintenance test pilot, an instructor pilot, a crew member, and/or an original equipment manufacturer (OEM). Such an RCA team comprising the members 102-106 provides a knowledge base relative to the technical area that is being analyzed under the RCM process.

Note that during the course of an RCM analysis, there may be data identified that the team members 102-106 are unable to provide. In such a scenario, the RCM system 100 retains information corresponding to the data for a complete analysis, so that such data may be sought from other sources, e.g., other experts not on the team, subsequent to the current RCM system session.

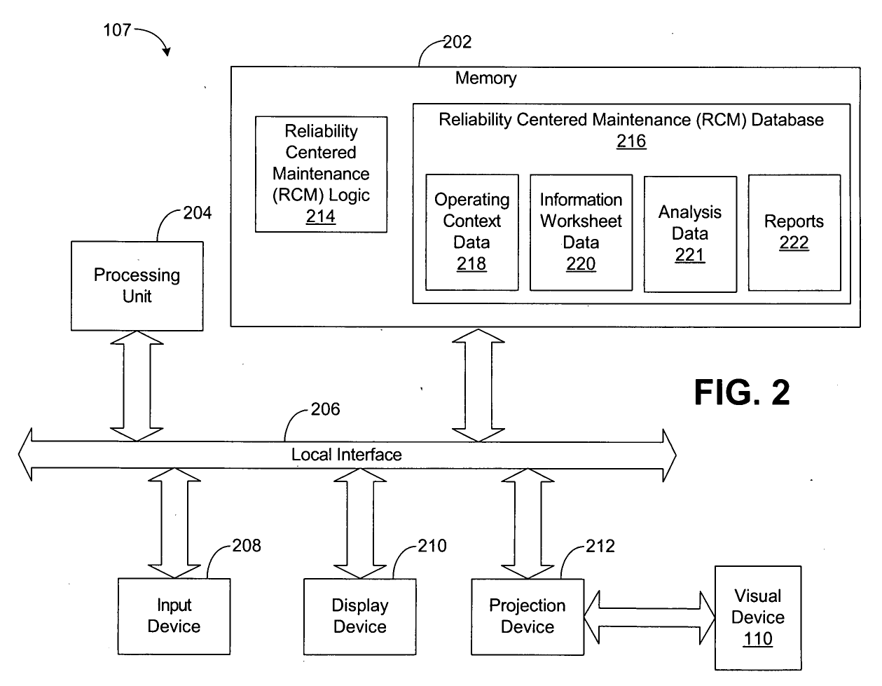

Prior to initiating the RCM analysis via the RCM device 107, the facilitator 101 preferably compiles operating context, described herein with reference to FIG. 2. Such an operating context orients the RCM team, stimulates brainstorming activities, outlines system characteristics and operating expectations in the system's environment, and serves as a baseline source of information and reference for future use, for example, in auditing and/or reporting.

To further narrow the analysis subject matter to an area that can be analyzed, the facilitator 101, alone, or in conjunction with the team members 102-106 may identify a scope of the RCM analysis related to the operating context. Thus, if the operating context centers on the flight control system of a helicopter, such an analysis can be broken down into two exemplary areas that may need separate RCM analyses in order to fully explore the maintenance related to the area. For example, the flight control system may comprise cockpit flight controls to the upper flight control actuators and swashplates to the rotor blades as distinct areas to address. Therefore, the scope of a particular RCM analysis might be aimed at the cockpit flight controls to the upper flight control actuators, only.

Prior to assembling the RCM team, the facilitator compiles the operating context related to the scope of the analysis that is to be performed by the RCM team. When the RCM team assembles, the team members 102-106 identify a plurality of functions corresponding to the operating context. In this regard, the team members 102-106 provide information regarding how equipment described in the operating context is to operate. For example, if the scope of the RCM analysis is the hydraulic system of an aircraft, the function identified may be that the system provides 2,600 to 3,000 pounds per square inch (psi) to power the flight control actuators.

Once a function has been identified, the team members 102-106 then identify functional failures corresponding to the identified functions. As the team members 102-106 identify the functional failures associated with the scope of the RCM analysis, the facilitator 101 enters data to the RCM system 100 indicative of the information provided by the RCM team.

Note that functional failures may be caused by human error. Further, note that failures may be evident and/or hidden. In this regard, an “evident failure” is one that would be recognized by a maintenance person or a crewperson during the ordinary course of his/her normal duties, and an evident failure it would be evident no matter how much time it takes for it to become physically evident. A “hidden failure” is a failure not recognizable or discernible by a maintenance person or a crew person during his/her normal duties but for a secondary event. For example, if a hydraulic line is leaking, a maintenance person, in his normal course of duties, might notice a decrease in hydraulic pressure, and such a failure would be evident. However, if a smoke alarm is disabled, such a failure would not be noticeable until a secondary event, e.g., a fire, and such a failure would be a hidden.

After the functional failures are identified, the team 102-106 identifies failure modes relating to the functional failures. The failure modes identify what may have caused the functional failure, and a single functional failure can be related to a plurality of failure modes.

After each corresponding failure mode is identified, the RCM team identifies a corresponding failure effect. In this regard, the team members 102-106 provide information relating to the effects of each of the modes, and the facilitator 101 enters data indicative of such effects into the RCM device 107. Such information is displayed on the visual device 110 during the RCM process.

The visual display device 110 may be, for example, a projection screen. As described herein, the RCM device 107 is configured to receive the described data.

Furthermore, the device 107 is configured to display the data to the facilitator 101. In addition, however, the data is displayed to the visual display 110 while the facilitator is entering the data. In this regard, the device 107 is further configured to increase the size of a data entry text box, discussed further herein, when the facilitator 101 is entering the data or while the RCM team is discussing the data that is to be entered. By allowing the text box to be enlarged, each team member 102-106 is able to visually capture the changes that are being made on the any corresponding GUI, which facilitates the RCM process.

The failure effects provided by the team members 102-106 preferably comprise information regarding, for example, a description of the failure process from the occurrence of the failure mode and how it manifests, how the failure mode affects safety and/or environmental integrity, operational capability and mission readiness, what must be done to repair the failure, physical evidence by which failure can be recognized, specific operating restrictions, secondary damage that may be caused by the failure and impact of loss of function.

Furthermore, the effects of the failure modes for each operating phase can be provided. In, the context of aircraft, the effects of the failure mode while the craft is on the ground, at take-off, in-flight, landing, and/or hovering, might be described.

This information is also entered into the RCM device 107 by the facilitator 101 and displayed to the display device 110.

Once failure modes and effects have been established for each identified function, the RCM team analyzes each failure mode to determine failure consequences. A failure consequence refers to how a failure mode matters. For example, the loss of one redundant hydraulic system in an aircraft might have operational consequences because it causes the aircraft, due to operating procedures to terminate the flight.

FIG. 2 depicts an exemplary RCM device 107 of the present disclosure. The exemplary RCM device 107 generally comprises a processing unit 204, an input device 208, a display device 210, and a projection device 212.

The RCM device 107 further comprises RCM logic 214 and an RCM database 216, which can be software, hardware, or a combination thereof. In the exemplary RCM device 107, RCM logic 214 and RCM database 216 are shown as stored in memory 202.

The processing unit 204 may be a digital processor or other type of circuitry configured to run the RCM logic 214 by processing and executing the instructions of the RCM logic 214. The processing unit 204 communicates to and drives the other elements within the RCM device 107 via a local interface 206, which can include one or more buses. Furthermore, an input device 208, for example, a keyboard, a switch, a mouse, and/or other type of interface, can be used to input data from a user of the RCM device 107, for example, the facilitator 101, (FIG. 1), and display device 210 can be used to output data to the facilitator 101 (FIG. 1).

The RCM device 107 may further comprise a projection device 212 can be connected to the local interface 206, such as one or more buses. The projection device 212 may capture information that the facilitator 101 enters into the RCM device 107 via the input device 208 and display such captured data to the visual device 110.

In the exemplary RCM device 107 of FIG. 2, the RCM logic 214 and the RCM database 216 are shown, as indicated hereinabove, as being implemented in software and stored in memory 202. However, the RCM logic 214 and the RCM database 216 may be implemented in hardware, software, or a combination of hardware and software in other embodiments.

An exemplary input device 208 may include, but is not limited to, a keyboard device, serial port, scanner, camera, microphone, or local access network connection.

An exemplary display device 210 may include, but is not limited to, a video display.

As noted herein, RCM logic 214 and the RCM database 216 are shown in FIG. 2 as software stored in memory 202. When stored in memory 202, the RCM logic 214 and the RCM database 216 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

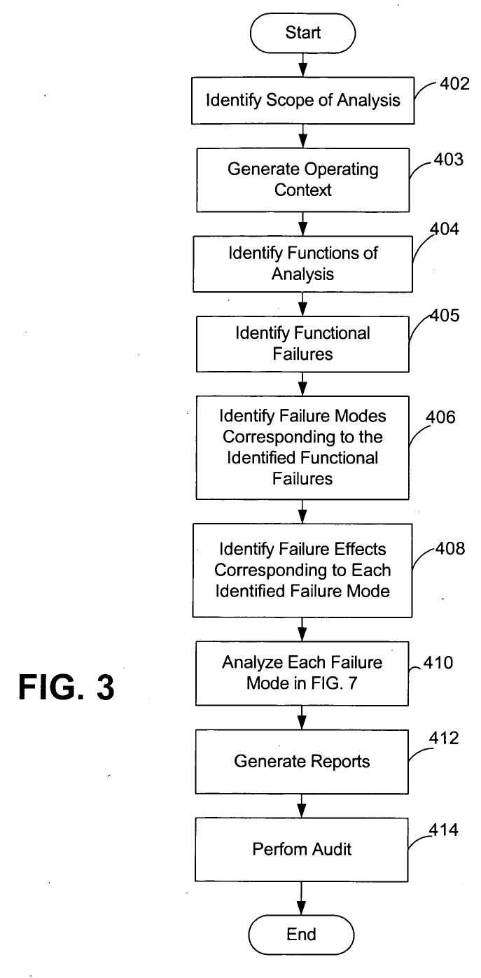

As described hereinabove with reference to FIG. 1, the facilitator 101 prepares an operating context to direct the RCM analysis. Such an operating context 218 is stored in the RCM database 214 in memory 202. As discussed hereinabove, an “operating context” is preferably an in-depth description of a system under analysis and other attributes regarding an RCM analysis that the RCM team uses to begin its RCM analysis. The operating context 218 is described in more detail with reference to FIG. 3.

FIG. 3 is a flowchart depicting an exemplary RCM process in accordance with the present disclosure. The initial step of the RCM process is identifying the scope of the analysis, as indicated in step 402. Identification of the scope of the analysis is performed when creating and evaluating the operating context 218 (FIG. 2) as described hereinabove. The scope of the analysis enables the facilitator 101 (FIG. 1) to narrow the breadth of the subject matter of the analysis to a workable ambit.

The facilitator 101 then creates a draft operating context 218 (FIG. 2), in-step 403. Such operating context 218 is stored in the RCM database 216 prior to the RCM analysis session. Once the scope of the analysis is identified in step 402 and the operating context is generated in step 403 which the RCM team, the RCM team identifies functions corresponding to the scope of the analysis in step 404. The functions identified by the RCM team related to those functions performed by the equipment related to the scope of the analysis, and which is preferably described in the operating context 218.

The RCM team further identifies functional failures, in step 405, and failure modes corresponding to the identified functional failure, in step 406. Once the functional failures and failure modes are identified, the RCM team identifies failure effects corresponding to each identified failure mode in step 408.

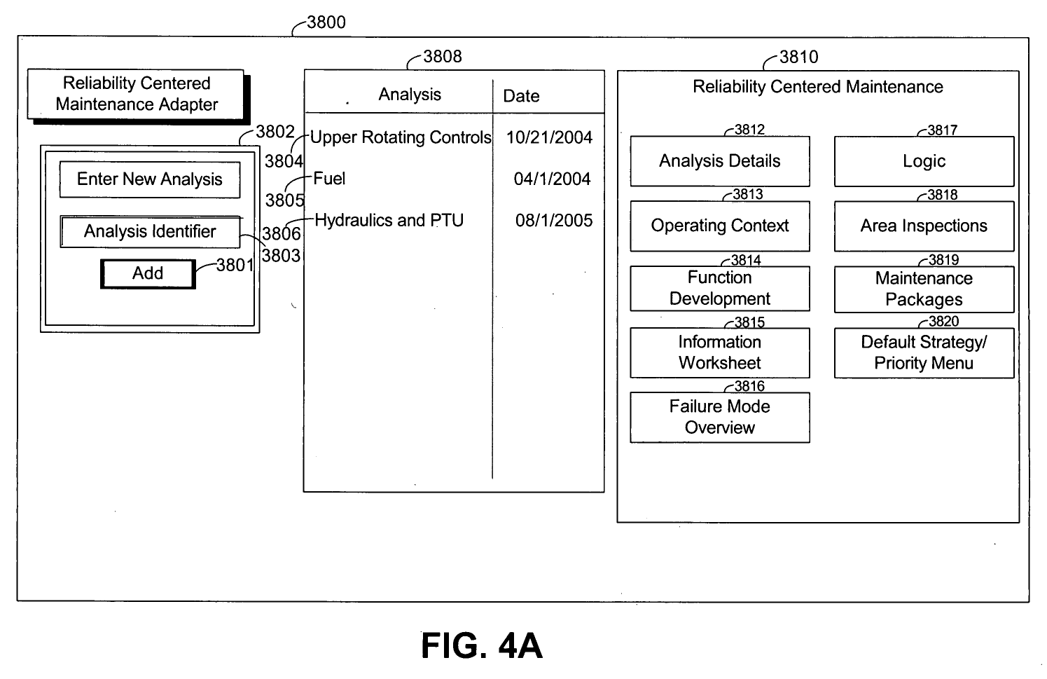

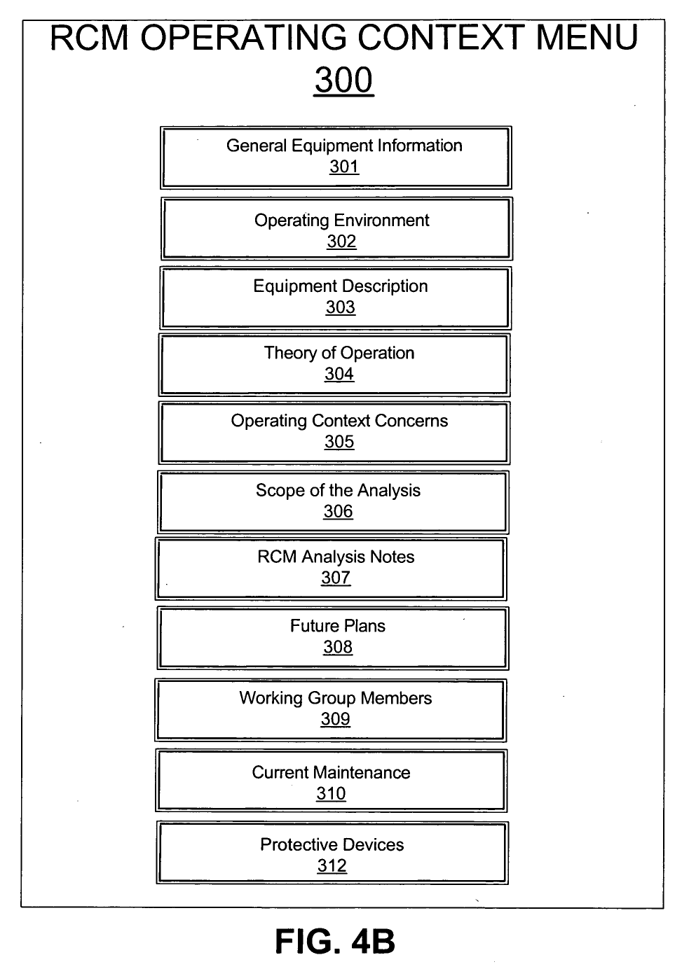

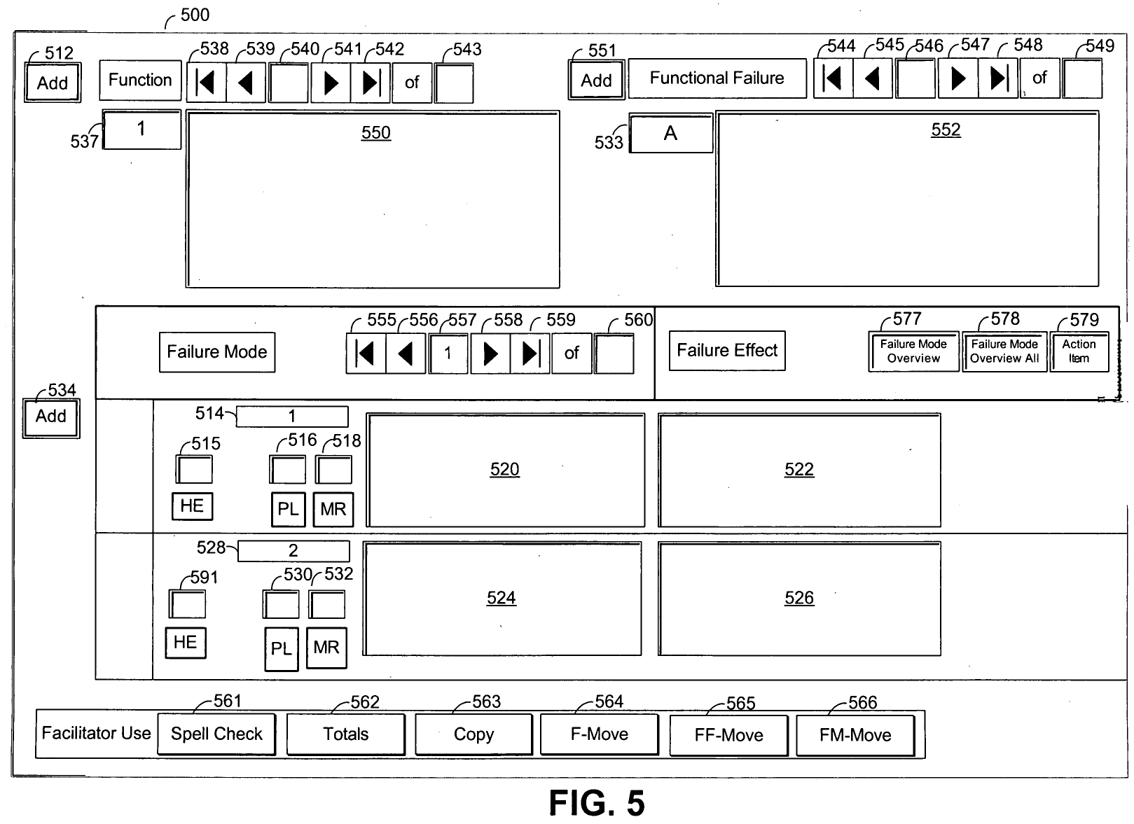

As will be described hereafter, in the final step of the RCM analysis, the RCM team analyzes each failure mode, as indicated in step 410. The process as described with reference to FIG. 4 is described in more detail with reference to FIGS. 5-7.

Additionally, the RCM logic 214 may then generate a set of reports, and store such reports in the RCM database 216, in step 412. These reports can then be printed and used by an audit team, in order to make decisions regarding what actions to take on the identified functions, functional failure, failure modes, failure effects, tasks and default strategies suggested by the team, as indicated in step 414.

An exemplary RCM Main Menu GUI 3800 is depicted in FIG. 4A. The exemplary RCM Main Menu 3800 comprises, for example, an “Enter New Analysis” box 3802, a selectable list of existing Analyses 3808, and a menu box 3810. Each will be described further herein.

When a user (not shown) desires to revisit an existing RCM analysis, the user selects, via the input device 208 one of the Analyses 3804-3806 previously created with the RCM logic 214, e.g., “Upper Rotating Controls,” “Fuel,” or Hydraulics and PTU.” If the user selects an existing Analysis 3804-3806, the RCM logic 214 accesses any information stored as operating context data 218, information worksheet data 220, analysis data 221, or reports 222, in the database 216. Thus, if the user thereafter selects one of a plurality of pushbuttons 3812-3820, the RCM logic 214 retrieves information stored in the database 216 corresponding to the selected function in accordance with the Analysis identifier.

Alternatively, the user may desire to create a new RCM analysis. Thus, the user might enter in an “Analysis Identifier” text box 3803 and select an “Add” pushbutton 3801. Thereafter, information entered via the RCM Main Menu 3800 will be stored in the RCM database 216 indexed by such Analysis identifier.

The menu box 3810 preferably comprises a plurality of pushbuttons 3812-3820 corresponding to a plurality of options available when performing an RCM analysis. In this regard, some exemplary pushbuttons are enumerated, including “Analysis Details” 3812, “Operating Context” 3813, “Function Development” 3814, “Information Worksheet” 3815, “Failure Mode Overview” 3816, “Logic” 3817, “Area Inspections” 3818, “Maintenance Packages” 3819, and “Default Strategy/Priority Menu” 3820.

The “Analysis Details” pushbutton 3812, when selected, displays a menu (not shown) with that enabling access to portions of the Analysis Data 221. For example, the menu may provide analysis date, audit dates, the names and contact information of the RCM team, names and contact information of the audit team members, executive summary information, miscellaneous notes, and facilitator pre-analysis notes.

The RCM Main Menu GUI 3800 may be customized depending upon the technical area under analysis and/or how the RCM system 100 will be used. For example, there may be a part identification section of the GUI 3800 that allows the RCM team to enter data related to specific parts to be used in the RCM analysis process.

FIG. 4B depicts an exemplary “Operating Context” GUI 300 in FIG. 4B that is displayed when the facilitator 101 selects the “Operating Context” pushbutton 3813. The exemplary RCM operating context GUI 300 preferably comprises a plurality of buttons 301-310, and each button represents a particular area of the operating context 218. Therefore, during the analysis, the facilitator 101 (FIG. 1) can activate the GUI 300 and activate a particular button 301-310, and each area in the operating context can be discussed, created, and/or modified. As described herein, the facilitator 101 may generate the operating context data 218 prior to a gathering of the RCM team and the facilitator 101 may also use the GUI 300 during such meeting thereby allowing the RCM team to provide input for the operating context data 218.

In this regard, when a particular area of the operating context data 218 is discussed, the facilitator 101 can actuate the button 301-310 corresponding to the operating context area. When the button 301-310 is selected by the facilitator 101, the RCM logic 214 displays to the display device 210 (FIG. 2) that text stored in the database 216 corresponding to the button selected. If no operating context data 218 has been entered for the selected area, then the RCM logic 214 displays an editable text box (not shown) in which data can be entered corresponding to the operating context button 301-310 selected. Preferably, the RCM logic 214 displays an editable text box that is populated with existing textual information stored by the facilitator 101 as the operating context 218 in the RCM database 216 prior to initiation of the RCM analysis with the RCM team.

Concurrent with displaying to the display device 210, the RCM logic 214 can further display to the visual device 110 via the projection device 212 the editable text box for viewing by the team members 102-106. Therefore, the RCM team can review the text to ensure that the information stored is accurate and up-to-date. If it needs to be modified, one or more of the team members 102-106 can provide textual changes to the facilitator 101, and the facilitator 101 can modify the textual content in the editable text box displayed by the RCM logic 214 via the input device 208.

Each button preferably represents an area in the operating context data 218. In this regard, the general equipment information button 301, when selected provides information related to general information about the equipment. For example, if a flight control system of an aircraft is being analyzed, a brief description of the aircraft, what powers it and the range of the aircraft may be provided in the operating context.

When the operating environment button 302 is selected, for example by the facilitator 101, the RCM logic 214 displays information about the operating environment, for example, how and where the aircraft is being used, i.e., desert military operations or commercial transport.

Other buttons may include equipment description button 303, theory of operation button 304, operating context concerns button 305, scope of the analysis button 306, RCM analysis notes button 307, future plans button 308 working group members button 309 and/or a current maintenance button 310.

As described hereinabove, the facilitator 101 preferably populates the operating context 218 prior to the RCM team assembly. However, there may be some areas of the operating context 218 that are not populated until the team assembles, such as, for example, the “RCM analysis notes” corresponding to button 307 is preferably populated during the analysis process and comprises information regarding terms, qualifications, and/or analysis assumptions. For example, the RCM analysis notes might indicate that the analysis assumes that the functions identified are not analyzed with respect to desert conditions.

The operating context data 218 is preferably stored in the RCM device 107, as described in more detail herein. Thus, when an RCM system session is initiated by the facilitator 101 related to the operating context data 218, the operating context data 218 can be displayed to the visual device 110 for reference and to stimulate discussion on topics related to the RCM analysis.

After the RCM team has reviewed the operating context data 218 and made any desired modifications and/or additions, the RCM team begins assembling an information worksheet described in more detail with reference to FIG. 5. The information worksheet proceeds in essentially the same manner as the operating context 218 review performed by the RCM team, i.e., the facilitator 101 elicits information from the team members 102-106, and the facilitator 101 enters information via the input device 208 into the RCM device 107.

The “Logic” pushbutton 3817, when selected, may display a screen that is used to view failure mode identifiers, described further herein. Each function identifier is associated with the failure mode analysis data, including whether the failure mode is evident or hidden, or what type of consequences result from the failure mode, and the failure mode's associated maintenance package and the failure mode associated logic that justifies the maintenance package.

The “Function Development” pushbutton 3814 displays a screen (not shown) that may be used by the RCM team and the facilitator 101 to identify functions. Preferably, the RCM logic 214 enables the facilitator to enlarge editable text boxes for entering data related to functions identified by the RCM team. The information worksheet analysis begins by the RCM team identifying specific functions of the equipment directly related to the scope of the analysis described in the operating context data 218. For example, if a hydraulic system is the scope of the analysis as described in the operating context, a primary function of the scope may be to supply 1500 psi to the lower control actuators and 3000 psi to the upper control actuators through fully redundant systems.

The RCM team 102-106 may further identify secondary functions of the scope of the operating context 218. For example, an exemplary secondary function of the hydraulic system may be to contain hydraulic fluid. In this regard, containing hydraulic fluid enables the hydraulic system to operate. Further, there is a filter in the hydraulic system to keep destructive particles from entering the system, there are gauges to visually indicate hydraulic temperature and pressure, and there are protective devices, such as, for example, relief valves to prevent pressure from increasing above a threshold value. These are merely examples of secondary functions of a hydraulic system. Other functions for the hydraulic system in other embodiments are possible.

While the RCM team is identifying the primary and secondary functions performed by equipment within the scope of the RCM analysis, the facilitator 101 enters information corresponding to the identified functions into the RCM system 100. Furthermore, as each function is entered into the system 100, the projection device 212 projects the information being entered onto the display device 110.

After the RCM team has provided a primary function and a plurality of secondary functions corresponding to the scope of the analysis, the RCM team then identifies functional failures associated with each of the primary function and secondary functions.

When identifying functional failures associated with the identified functions of the equipment, the RCM team distinguishes between total failures and partial failures. In this regard, a total failure refers to a failure that causes an entire system to cease operating. For example, with respect to the function identified hereinabove, i.e., to supply 1500 psi to the lower control actuators and 3000 psi to the upper control actuators through fully redundant systems, a total failure would be that both hydraulic systems fail. For example, a bullet takes out each hydraulic system. However, another failure might be that a hydraulic system produces less than 1500 psi, and such a failure is referred to as a partial failure.

While the RCM team 101-106 is identifying the functional failures associated with each function performed by equipment within the scope of the RCM analysis, the facilitator 101 enters information corresponding to the identified failures into the RCM system 100. Furthermore, as each failure is entered into the system 100, the projection device 212 projects the information being entered onto the visual device 110.

After the RCM team , 101-106 identifies the functional failures, the RCM team identifies the failure modes and effects associated with each functional failure. In this regard, the failure mode is the specific cause of the failure. The failure effect includes a description of what happens from the moment the failure mode occurs.

Failure effects, as described hereinabove, can include, but are not limited to, impact of loss of function on the system mode analysis, effect on operating safety, and how the failure mode breaches an environmental standard or regulation, physical evidence by which a failure can be recognized, specific operating restrictions resulting from the failure mode, and secondary damage.

While the RCM team is identifying the failure modes and failure effects associated with each functional failure within the scope of the RCM analysis, the facilitator 101 enters information corresponding to the identified modes and effects into the RCM system 100. Furthermore, as each failure mode and failure effect is entered into the system 100, the projection device 212 projects the information being entered onto the visual device 110. Note that the failure mode may include failure due to human error. For example, during normal duties, a worker may over-torque a bolt, which would constitute a failure mode. A corresponding failure effect would be that the bolt shears.

Once the RCM team has completed the steps of identifying functions, functional failures, failure modes, and failure effects, the RCM logic 214 store data entered into the information worksheet as information worksheet data 220.

The RCM team then visually analyzes the information worksheet data 220 and identifies, for example, relevant tasks that may be performed corresponding to the functions, functional failures, failure modes, and failure effects. Such analysis data 221 is stored in the RCM database 216. Furthermore, the RCM logic 214 may also generate reports from the information worksheet data 220 and the analysis data 221 to generate reports 222 that the RCM logic 214 stores in the RCM database 216.

Note that in one embodiment of the RCM device 107, each of the buttons 301-310 displays to the display device 210 and the visual device 110 editable text windows exhibiting the information corresponding to each button 301-310. The facilitator 101 can then enter suggested information via the input device 208, and the RCM logic 214 displays the changes on the visual device 110 and the display device 210 as the changes are being made. Such a system 100 thereby more easily effectuating the team analysis.

FIG. 5 depicts an exemplary information worksheet GUI 500 in accordance with an embodiment of the present disclosure. The GUI 500 is used during the identification of each function, functional failure, failure mode, and failure effect described in steps 402-408 (FIG. 4). Note that the GUI 500 is for exemplary purposes only, and other GUIs in other embodiments of the RCM device 107 may be used to capture such data described.

In this regard, the facilitator 101 (FIG. 1) selects the Information Worksheet pushbutton 3815, and the RCM logic 214 displays to the display device 210 (FIG. 2) and correspondingly to visual device 110 (FIG. 1), the GUI 500. The GUI 500 is used in order to identify each function, functional failure, failure mode, and failure effect by the RCM team during the RCM analysis.

As described hereinabove, the RCM team identifies functions performed by the equipment, as indicated in step 404 (FIG. 4) defined by the scope of the analysis identified in step 402 (FIG. 4), and described in the operating context 218 (FIG. 2) generated in step 403 (FIG. 4).

The information worksheet GUI 500 preferably comprises a button 512, which is actuated by the facilitator 101, and, when actuated, enables the facilitator to enter data in the text box 550. Such data entered into the text box 550 preferably describes a function of the system under analysis identified by the RCM team. An identifier corresponding to the displayed function description in box 550 is displayed in box 537.

Further, the information worksheet GUI 500 comprises navigational buttons 538-542. When the button 538 is selected, the RCM logic 214 (FIG. 2) displays data indicative of the first function of a plurality of functions to the box 550 Further, when the button 542 is selected, the RCM logic 214 (FIG. 2) displays data indicative of the last function in the plurality. Buttons 539 and 541, when selected, incrementally scroll bi-directionally through the plurality of functions. Box 540 displays an identifier, e.g., a number such as “1,” that identifies the function currently displayed, and the box 543 displays the total number of functions in the plurality of functions stored in the RCM database 216 corresponding to the currently selected operating context.

Furthermore, as described hereinabove, each function identified may have associated with it a plurality of functional failures. Information corresponding to the currently displayed functional failure is displayed in an editable text box 552. In this regard, the facilitator 101 may enter a plurality of functional failures, via an “Add” button 551, as identified by the RCM team. The information worksheet GUI further comprises the buttons 544-549, which work substantially similar to those buttons 538-543 described with reference to the function text box 550. The facilitator 101 selects the “Add” button 551 and enters text in a functional failure text box 552 information corresponding to a functional failure identified by the RCM team during the analysis. An identifier corresponding to the displayed functional failure in box 552 is displayed in box 533.

As additional information is added regarding new functions and corresponding functional failures, the RCM logic 214 stores such newly added information in information worksheet data 220 in the RCM database 216.

As described hereinabove with reference to steps 406 (FIG. 4)-408 (FIG. 4), the RCM team identifies a plurality of failure modes and failure effects associated with each functional failure. Thus, the information worksheet GUI 500 further comprises a failure mode editable text box 520 and a failure effect editable text box 522 for entering information defining a failure mode and a failure effect associated with the function currently displayed in text box 550 and functional failure currently displayed in text box 552.

Buttons 555-560 behave substantially similar to those buttons 538-543 described hereinabove. Additionally, the facilitator 101 may select the “Add” pushbutton 534 and enter text in the failure mode text box 520 information corresponding to an additional failure mode identified by the RCM team during the analysis.

Furthermore, the RCM logic 216 associates each failure mode and effect identified, for example in box 520 and 522 with a unique identifier. Thus, the GUI 500 further comprises a text box 514 for displaying such unique identifier associated with the failure mode and effect corresponding to box 520 and 522. For example, boxes 537, 533, and 514 comprise the string “1A1,” which identifies the failure mode in text box 520 corresponding to the functional failure identified in box 552, and the function identified in box 550. Such a string is hereinafter referred to as a “failure mode identifier.”

Associated with each failure mode text box 520 and failure effect text box 522 are selectable boxes 515, 516, and 518. Such boxes 515, 516, and 518 may be selected by the facilitator 101 in order to add additional information related to the identified failure mode.

Box 515 is a human error (HE) selectable box, box 516 is a parking lot (PL) selectable box, and box 518 is a mode remarks (MR) selectable box. If one of these boxes is selected, then the RCM logic 214 stores “Information Worksheet Data” 220 related to such selected box in the database 216. For example, if the HE box 515 is selected, such selection indicates that the failure mode under analysis is of a human nature type of failure mode, e.g., the part is installed backwards. Such human error information may be related to data corresponding to how a human error might have played into the existence of the identified failure mode in text box 520.

If the parking log box 516 is selected, then the facilitator may enter information into an editable text box (not shown) that may be displayed when the box 516 is selected, or otherwise. Such parking lot information may identify that there needs to be some action taken with respect to the identified failure mode in text box 520 before and RCM analysis can be performed on the failure mode. The parking lot data is described further herein.

As another example, if the “MR” box 516 is selected, then the facilitator may enter information into an editable text box (not shown) that may be displayed when the box 518 selected, or otherwise. Such mode remarks information may identify any other information related to the identified failure mode in text box 520.

When the facilitator 101 selects the “Add” button 534, the RCM logic 214 displays an additional failure mode entry identified by the number “2” in box 528.

In addition, additional text boxes, e.g., 524 and 526, are displayed for entering data indicative of additional failure modes and failure effects associated with the displayed functional failures and functions in text boxes 550, and 552, respectively. In this regard, the facilitator 101 may enter information related to a second failure mode, identified in a box 528 by a “2,” in text box 524. Text box 528 identifies the failure mode and effect displayed in boxes 524 and 526, and boxes 591, 530, and 532 behave substantially similar to boxes 515, 516, and 518 described hereinabove.

The GUI 500 further comprises pushbuttons 577-579. Pushbutton 577 is a “Failure Mode Overview” pushbutton. When the pushbutton 577 is selected, the RCM logic 214 opens a second instantiation of the GUI 500 populated with data corresponding to the failure mode currently displayed on the first instantiation of the GUI 500. The second instantiation of the GUI 500 may be edited by the user, however, the facilitator 101 will be unable to scroll through the entire enumerated list of failure modes.

Pushbutton 578 is a “Failure Mode Overview All” pushbutton that, when selected, the RCM logic 214 opens a second instantiation of the GUI 500 as described hereinabove for pushbutton 578. However, when pushbutton 578 is selected, the RCM logic 214 displays the data in the second instantiation of the GUI 500 corresponding to the failure mode currently displayed in the first instantiation and the facilitator 101 can use the navigational controls to incrementally display or decrementally display other failure modes in the enumerated list. Therefore, the facilitator 101 can copy data from one failure mode from the second instantiation to the first instantiation of the GUI 500.

Pushbutton 579 is an “Action Item” pushbutton that, when selected, displays a form (not shown) in which the facilitator may enter information related to a particular action that may be needed corresponding to the identified failure mode. For example, the form may comprise a text box for entering data corresponding to the due date of the action item, resolution of the action item, and data describing the action item that may be needed.

The GUI 500 may further comprise facilitator pushbuttons 561-566 for use during the RCM process. A spell check pushbutton 561 may be selected to check the correct spelling used in each of the text boxes 550, 552, 520, 522, 524, and/or 526. A totals pushbutton 562 may be selected in order to display a window (not shown) to the display device 210 (FIG. 2) and the visual device 110 (FIG. 1) the totals for the present analysis. For example, the window may display total functions, functional failure, and failure modes. In addition, the window may display totals per function, including total functional failures and total failure modes per function.

A push button 563 may be selected to copy text in one of the text boxes 550, 552, 520, 522, 524, and/or 526. Therefore, the facilitator 101 may copy and paste text provided for one function, functional failure, failure mode, and/or failure effect to another. Furthermore, pushbuttons 564-566 may be selected to move functions, functional failures, or failure modes to another place in the enumerated list.

Thus, the GUI 500 enables the RCM team to enter a plurality of functions, functional failures, failure modes, and failure effects. The RCM logic 214 stores the information entered by the facilitator 101 as data 220 in the RCM database 216.

Addition, the RCM logic 214 stores such data in an enumerated list corresponding to the user's desires. Therefore, each failure mode can be identified with a unique identifier, e.g., “1A1,” or “1A2.”

Once the RCM team has entered data associated with the functions, functional failures, failure modes, and failure effects, the RCM logic 214 stores the compiled information worksheet depicted in FIG. 5 that lists each function and each function's associated functional failures, failure modes, and failure effects. Such information is preferably printed for further use by the RCM team in the analysis performed as indicated in step 410 of FIG. 4.

In this regard, each team member 102-106 and the facilitator 101 can be provided a copy of the information worksheet data 220 when the RCM team performs the analysis indicated in step 410, which is described in more detail hereafter.

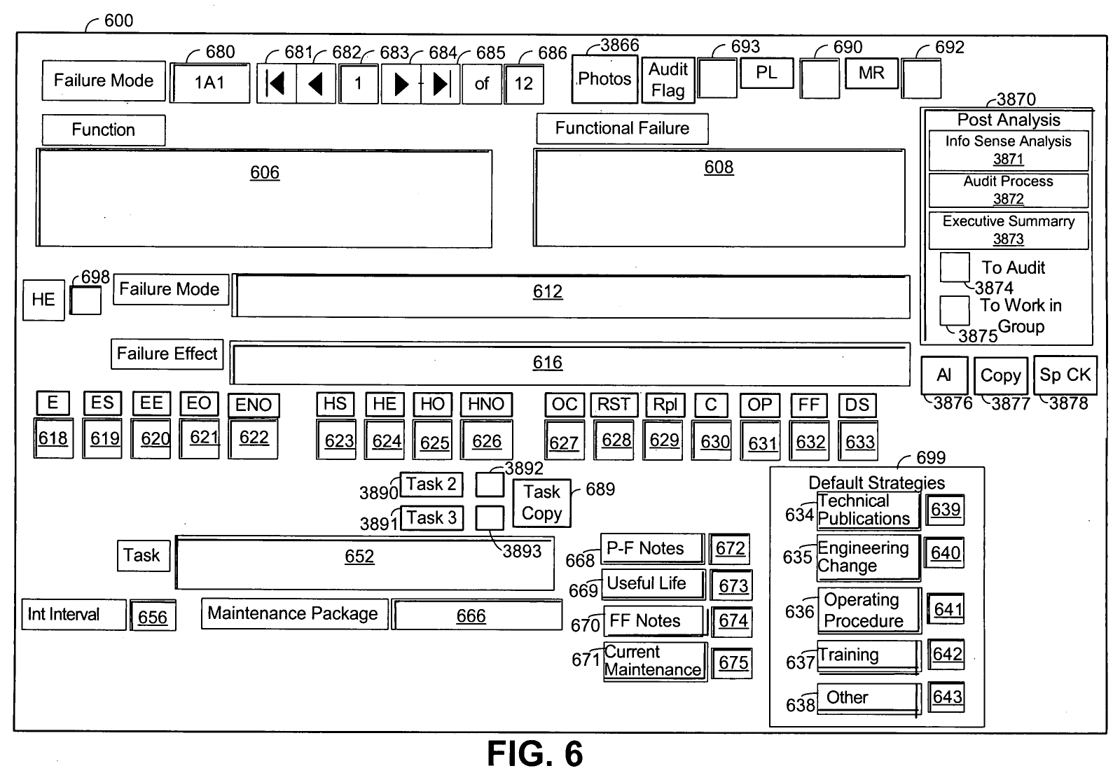

FIG. 6 depicts an exemplary GUI 600 in accordance with an embodiment of the present (FIG. 5) disclosure. When the user selects the “Failure Mode Overview” pushbutton 3816 (FIG. 4A), 577, or 578 the RCM logic 214 displays the GUI 600, which is used during the analysis step 410 of each function, functional failure, failure mode, and failure effect indicated by the information worksheet data 220 entered in the GUI 500 (FIG. 5).

In this regard, the RCM logic 214 displays a first failure mode of a plurality of failure modes previously defined by the RCM team, and identifies the failure mode by its failure mode identifier, e.g., “1A1.”

The RCM logic 214 populates GUI 600 using the information worksheet data 220 created from the identification of the functions, functional failure, failure modes, and failure effects in GUI 500. The RCM logic 214 displays in a text box 680 an identifier that identifies the failure mode currently displayed in text box 612. Thus, the RCM team can use such identifier to locate such failure mode in the information worksheet data 220. The GUI 600 further comprises navigation buttons 680-686, which work substantially similar to the navigation buttons 538-543 (FIG. 5).

Therefore, the facilitator 101 can navigate through a stored enumerated list of failure modes and corresponding functions and functional failures.

The function and the functional failure associated with the currently displayed failure mode identifier, “1A1,” are displayed in text boxes 606 and 608, respectively. The RCM logic 214 displays the failure mode description corresponding to the mode identified in text box 680 in text box 612 and a corresponding failure effect in text box 616.

Once the failure mode is selected, e.g., “1A1,” and the RCM logic 214 displays data associated with the function, functional failure, failure mode and failure effect corresponding to the selected mode in box 680, the RCM team analyzes the failure mode identified, as described hereinafter. Note that the information entered into the GUI 500 (FIG. 5) is displayed in GUI 600 corresponding to the failure mode selected by the facilitator for analysis.

The GUI 600 comprises selectable input boxes 618-633, which are discussed further herein. Each selectable input box 618-633 indicates a logical analysis parameter. Selectable boxes 618-622 are indicative of evident failure modes, and each box represents a particular aspect of an evident failure mode. In this regard, box 618 is selected if the failure mode is evident, box 619 is selected if the failure mode is evident and the failure mode has safety consequences, box 620 is selected if the failure mode is evident and has environmental consequences, box 621 is selected if the mode is evident and has operational consequences, and box 622 is selected if the failure mode is evident and has non-operational consequences. Note that a failure mode is “evident” if the loss of function or secondary damage becomes evident to an operating crew during normal duties at any time during operation (see definition above).

Selectable boxes 623-626 are indicative of hidden failure modes, and each box represents a multiple failure consequence. In this regard, box 623 is selected if the has multiple failure safety consequences, box 624 is selected if the multiple failure has environmental consequences, box 625 is selected if the multiple failure mode is hidden and has operational consequences, and box 626 is selected if the multiple failure has non-operational consequences. Note that a failure mode is “hidden” if the loss of function or secondary damage does not become evident to an operating crew on its own during normal duties.

Additionally, selectable boxes 627-633 are indicative of a plurality of failure management strategies. Selectable box 627 is indicative of an on-condition maintenance type of failure management strategy. A failure mode responds to an on-condition maintenance type failure task if it is possible to detect evidence of impending failure, if the P-F interval is reasonably consistent and if the P-F interval is long enough to manage the consequences of a failure mode. Further, a failure mode responds to an on-condition task if it is possible to monitor the equipment at intervals less than the P-F interval (amount of time or the number of stress cycles that elapse between the point where a potential failure occurs and the point where it deteriorates into a functional failure). Such a time interval is known in the art and is hereinafter referred to as the “P-F interval.”

Therefore, the facilitator 101 queries the RCM team regarding whether the failure mode currently being analyzed could be managed by an on-condition maintenance task. The facilitator 101 asks questions of the RCM team that elicit responses to determine whether the failure mode is such a failure mode, as described hereinabove. If the RCM team determines that the failure mode is one that responds to an on-condition maintenance task, then the facilitator 101 selects the on-condition box 627. Tasks are described further herein.

Selectable text box 628 is indicative of a failure mode that responds to a restoration task. A failure mode responds to a restoration task if there is an identifiable wearout age, i.e., an age at which there is a rapid increase in the conditional probability of failure. Further, such a failure mode is one in which the failure mode survives until that age at which there is a rapid increase in the conditional probability and a restoration task restores the original failure resistance.

Therefore, the facilitator 101 queries the RCM team regarding whether the failure mode currently being analyzed would respond to a restoration task. The facilitator asks questions of the RCM team that elicits responses to determine whether the failure mode requires a restoration task in accordance with a restoration task strategy described hereinabove. If the RCM team determines that the failure mode will respond to a restoration task, then the facilitator 101 selects the restoration box 628.

Selectable text box 629 is indicative of a failure mode that will respond to a replacement task. A failure mode will respond to a replacement task if there is an identifiable wearout age, i.e., an age at which there is a rapid increase in the conditional probability of failure. Further, a failure mode is responsive to a replacement task the failure mode survives to the identified wearout age.

Therefore, the facilitator 101 queries the RCM team regarding whether the failure mode currently being analyzed will respond to a replacement task in accordance with the replacement task criteria. The facilitator asks questions of the RCM team that elicits responses to determine whether the failure mode is responsive to a replacement task in accordance with the replacement description hereinabove. If the RCM team determines that the failure mode will respond to a replacement task, then the facilitator 101 selects the replacement box 629.

Selectable text box 630 is indicative of a failure mode responsive to a combination of tasks failure management strategy. A failure mode is responsive to a combination of tasks if the failure mode will respond to a combination of on-condition, restoration, and/or replacement tasks.

Therefore, the facilitator 101 queries the RCM team regarding whether the failure mode currently being analyzed is responsive to a combination of tasks by analyzing the failure mode under each of the descriptions hereinabove regarding on-condition, restoration and replacement. If the RCM team determines that the failure mode will respond to a combination of tasks, then the facilitator 101 selects the replacement box 630.

Selectable text box 631 is indicative of a failure mode that responds to an operational check. This default strategy is not considered proactive maintenance. A failure mode responds to an operational check if the failure mode causes a failure condition that can be inspected/checked before, during, or after operation, if it is intolerable to operate with the failure condition and if performing the inspection/check reduces the level of risk to a tolerable level (safety/environmental consequences) or the inspection/check is cost effective (operational/non-operational consequences).

In this regard, an operational check is one that handles an evident failure mode that could adversely affect safety/environment, operation, and/or other non- operational consequences, for example in an aircraft the failure mode might adversely affect flight safety or mission completion but cannot be predicted or prevented. Failure modes that respond to operational checks are “evident” and are not subject to failure-finding logic. A failure mode responsive to an operational check is one that causes a failed state, that is, it is immediately unable to perform its function or it has deviated from the original condition which is unsatisfactory to the user as soon as it occurs.

As an example, a functional failure for an aircraft might be identified by the RCM team described as the inability of the equipment to contain hydraulic fluid.

Further, the RCM team identifies a failure mode responsive to an operational check corresponding to such a functional failure is that the hydraulic fill cap was not properly replaced. In such an example, as soon as the functional failure occurs, i.e., inability to contain hydraulic fluid, it is unable to contain hydraulic fluid in a way that is required by the user. That is, if the aircraft were flown with a loose cap, hydraulic fluid would leak from the respective hydraulic system causing low pressure. In many cases, this would cause the mission/flight to be aborted due to the loss of hydraulic pressure.

However, when this failure mode is analyzed, it is not possible to detect physical evidence of impending failure because as soon as the cap is not properly replaced, it has functionally failed, and as described further herein, such a functional failure is not classifiable as a failure mode responsive to an on-condition task.

In this regard, a failure mode responsive to an operational check is random, and there exists no identifiable age at which there is a rapid increase in the conditional probability of failure. Thus, as described further herein, such a failure mode is not classifiable as a failure mode that is responsive to a restoration and/or a replacement task.

Therefore, when analyzed with respect to an on-condition, a restoration, and/or replacement task, no scheduled maintenance would necessarily be identified.

However, it would be desirable to necessarily manage such a failure mode, for example with respect to an aircraft, prior to take-off.

The operational check, as described further herein, is for identifying and dealing with evident failure modes that do not meet the requirements for on-condition or preventive maintenance. The process of identifying failure modes responsive to an operational check is considered a default strategy but may also lead to an additional default strategy, described further herein.

Therefore, the facilitator 101 queries the RCM team regarding whether the failure mode currently being analyzed is responsive to an operational check. If the RCM team determines that the failure mode will respond to an operational check in accordance with the description hereinabove, and there is a particular inspection/check that can reduce the risk of failure to an acceptable level or is cost effective, then the facilitator 101 places a designation, e.g., a “Y” in the operational check 631.

If the RCM team determines that the failure mode will not respond to an on-condition task, a restoration task, a replacement task, or a combination of tasks or an operational check, then the facilitator places an indication in box 633, as default strategies dictate. A default strategy is a failure management strategy. The RCM system offers tools to identify more than scheduled maintenance, failure finding tasks, operational checks, and area inspections. Other all-encompassing recommendations that may result from an RCM analysis are: changes/additions to operating procedures, technical publications, and/or training programs, engineering redesigns to the equipment, and/or any other additions/changes that may be required to manage the consequences of failure.

Once the RCM team has identified a failure mode and failure effect the RCM team then determines a technically appropriate task and failure effect. In this regard, the task is an action or actions that can be performed to manage the consequences of the failure mode on the equipment that is being analyzed. The task is preferably created by the RCM team, and the facilitator 101 enters data defining the task in the text box 652, which the RCM logic 214 stores in the RCM database 216.

Furthermore, the GUI 600 may comprise selectable boxes 3892 and 3893 that indicate additional tasks associated with the currently displayed failure mode. In this regard, if the “C” box 630 is selected indicating that a combination of tasks is appropriate for the failure mode currently displayed in box 612, then the facilitator may select one or both of boxes 3892 or 3893 to indicate additional tasks are defined.

The facilitator 101 may then select a “Task 2” pushbutton 3890 and a “Task 3” pushbutton 3891 as required to enter data related to the identified combination of tasks. Furthermore, when a “Task Copy” pushbutton is selected, the RCM logic 214 may display a window (not shown) comprising text boxes for identifying tasks previously entered. The facilitator may then copy data from the displayed window.

Further, the RCM team identifies an initial interval for performing the task described in text box 652 in block 656. For example, if the task assigned is to perform a vibration test on the equipment, the interval indicated may be every 30 flight hours, 60 flight hours, or the like. Thus, the facilitator 101, in accordance with the information provided by the RCM team enters the interval in box 656.

The GUI 600 further comprises a box 666 in which the facilitator 101 can identify a maintenance package, which can include the currently displayed task for managing the currently displayed failure mode. A maintenance package is a set of maintenance tasks that are to be performed at a particular time, for example daily, weekly, or after a predetermined number of flight hours. Thus, the RCM team can select from various packages available that are currently performed on the aircraft or vehicle that is the subject of the operating context 218 in which the task is to be included.

The GUI 600 further comprises buttons 668-671 and 634-638 for entering additional information into the RCM database 216 (FIG. 2) and associated boxes 672-675 and 639-643 that provide an indicator, e.g., a checkmark, when data has been entered corresponding to the associated push button 668-671 and 634-638, respectively.

The RCM logic 214 may display an editable text box (not shown) when the P-F Notes push button 668 is selected by the facilitator 101. The facilitator 101 may enter additional information corresponding to the P-F interval, as described hereinabove, corresponding to the currently displayed failure mode. Further, when information has been entered relating to the P-F interval, box 672 may exhibit an indication of such, for example there may be a check mark in the box 672. The RCM logic 214 stores such information in the RCM database 216 associated with the failure mode information.

The RCM logic 214 may display an editable text box (not shown) when the useful life push button 669 is selected by the facilitator 101. The facilitator 101 may enter additional information corresponding to the useful life of a failure mode, for example, the age at which there is a rapid increase in the conditional probability of failure. Further, when information has been entered relating to the useful life, box 673 may exhibit an indication of such, for example there may be a check mark in the box 673. The RCM logic 214 stores such information in the RCM database 216 associated with the failure mode information.

The RCM logic 214 may display an editable text box (not shown) when the FF notes push button 670 is selected by the facilitator 101. The facilitator 101 may enter additional information. Further, when information has been entered relating to the FF notes, box 674 may exhibit an indication of such, for example there may be a check mark in the box 674. The RCM logic 214 stores such information in the RCM database 216 associated with the failure mode information.

The RCM logic 214 may display an editable text box (not shown) when the current maintenance push button 671 is selected by the facilitator 101. The facilitator 101 may enter additional information corresponding to the proactive maintenance relating to the current maintenance schedule for that failure mode. Further, when information has been entered relating to the current maintenance, box 675 may exhibit an indication of such, for example there may be a check mark in the box 675. The RCM logic 214 stores such information in the RCM database 216 associated with the failure mode information.

The RCM logic 214 may display an editable text box (not shown) when the technical publications push button 634 is selected by the facilitator 101. The facilitator 101 enters additional information corresponding to the technical publications. default strategy related to the currently displayed failure mode, such as, for example, the information may comprise suggested changes, additions, and/or deletions that the RCM team suggests in the technical publications. Further, when information has been entered relating to the changes in technical publications, box 639 may exhibit an indication of such, for example there may be a check mark in the box 639. The RCM logic 214 stores such information in the RCM database 216 associated with the failure mode.

The RCM logic 214 may display an editable text box (not shown) when the engineering change push button 635 is selected by the facilitator 101. The facilitator 101 may enter additional information corresponding to the engineering change default strategy related to the currently displayed suggested by the RCM team during the RCM analysis. For example, the RCM team may decide that a piece of equipment, if designed differently, may help to manage the consequences of failure associated with the currently displayed failure mode. Further, when information has been entered relating to the engineering changes, box 640 may exhibit an indication of such, for example there may be a check mark in the box 640. The RCM logic 214 stores such information in the RCM database 216 associated with the failure mode.

The RCM logic 214 may display an editable text box (not shown) when the operating procedure push button 636 is selected by the facilitator 101. The facilitator 101 may enter changes corresponding to the operational procedures default strategy related to the currently displayed failure mode suggested by the RCM team during the RCM analysis. Further, when information has been entered relating to the operating procedures, box 641 may exhibit an indication of such, for example there may be a check mark in the box 641. The RCM logic 214 stores such information in the RCM database 216 associated with the failure mode.

The RCM logic 214 may display an editable text box (not shown) when the training default strategy push button 637 is selected by the facilitator 101. The facilitator 101 may enter information regarding changes corresponding to the training default strategy related to the currently displayed failure mode suggested by the RCM team during the RCM analysis. Further, when information has been entered relating to the training, box 642 may exhibit an indication of such, for example there may be a check mark in the box 642. The RCM logic 214 stores such information in the RCM database 216 associated with the failure mode information.

The information described hereinabove that is entered via the GUIs 500 and 600 are stored in the RCM database 216. Thus, upon completion of such analysis and entry of information, the RCM logic 214 can query the database 216 and generate a plurality of reports associated with the data entered.

For example, the RCM logic 214 may create a report listing each function and functional failure and each failure mode and effect associated with each functional failure. Further, the RCM logic 214 may create a report comprised of each failure mode and its associated RCM analysis, including whether the failure mode is hidden or evident, whether the failure mode affects safety, environmental guidelines, operation of the equipment, or whether the failure mode has non-operational consequences. Further the RCM logic 214 may create a report that lists each of the failure modes and the tasks associated with the failure modes.

With respect to the default strategies, the RCM logic 214 may compile the tasks associated with each failure mode identified as a default strategy. In this regard, the RCM logic 214 may create, for example, a pre-flight or daily maintenance checklist associated with those failure modes that are not subject to proactive maintenance as described with reference to on-condition tasks, restoration tasks, replacement tasks, and/or a combination of tasks.

Such information may further be compiled by the RCM logic 214 to create an audit package. In this regard, the GUI 600 further comprises an “Audit Flag” selectable box 693, that, when selected, indicates that the current RCM analysis is to be prepared for an audit. An audit package preferably comprises a plurality of reports resulting from the RCM analysis. Such reports may be used by a secondary team to analyze the RCM analysis, which can then be reviewed by a senior management team.

The initial analysis performed by the RCM team and recorded by the facilitator in the RCM system is the first tier. The second tier analysis can be performed on the captured data in the form of auditing and the audit package created by the RCM system, as indicated in step 414 of FIG. 3.

In addition, the GUI 600 comprises a “Post Analysis” menu 3870. The “Post Analysis” menu comprises additional components that enable a facilitator 101 to enter additional information after the RCM analysis by the RCM team has been performed.

Menu 3870 comprises an “Info Sense Analysis” pushbutton 3871, “Audit Process” pushbutton 3872, and a “Failure Mode Executive Summary” pushbutton 3873. When pushbutton 3871 is selected, the RCM logic 214 enables the facilitator 101 to enter data indicative of information obtained since the date of the original analysis with the RCM team. When pushbutton 3872 is selected, the RCM logic 214 receives information for achieving consensus between the RCM team and an audit team. When pushbutton 3873 is selected, the RCM logic 214 receives data indicative of a summary of the RCM analysis presently selected.

Selection boxes 3874 and 3875, when checked, send data to the auditors for auditing or to the RCM team if the auditor have provided notes. In this regard, any data entered can be, for example, emailed to an individual or a group by selection of one of these boxes 3874 and 3875. Additionally, when such boxes are check, the RCM logic 214 stores such check data corresponding to the displayed failure mode or to the RCM analysis. Thus, when generating reports, the RCM logic 214 may include such a failure mode on a report to, for example, an audit team if the audit box 3874.

Action Item pushbutton 3876, when selected, enables a user or the facilitator 101 to enter data regarding action to be taken by one of the groups or individuals involved in the RCM process, i.e., the facilitator, the auditors, a member of the RCM team, or the like. When the “Copy” pushbutton 3877 is selected, the RCM logic 214 opens up another GUI 600 from which the facilitator can copy data. Thus, the facilitator can toggle between the fist GUI 600 and the second GUI 600. The “Sp CK” pushbutton, when selected, checks the spelling on the GUI 600.

GUI 600 further comprises a “Photo” pushbutton 3866. When the pushbutton 3866 is selected, a photograph corresponding to the displayed failure mode may be. displayed in a separate window. In this regard, the photo may identify the equipment at issue with respect to the failure mode or may illustrate other details regarding the failure mode.

Furthermore, the GUI 600 comprises a “PL” text box 690 and a “MR” text box 692. As described herein, “PL” and “MR” are indicative of data that the facilitator 101 enters when additional information is needed in order to further analyze the failure mode at issue or when the facilitator 101 determines that additional data needs to be associated with the failure mode, respectively. If the “PL” box 516 or the “MR” box 518 was selected for the failure mode during analysis in GUI 500, then such boxes 690 and 692 will exhibit an identifier, e.g., a check symbol or other identifier, that indicates that there is additional data in the “parking lot,” as described herein, or in the “mode remarks” section, as described herein.

Furthermore, the GUI 600 comprises an “HE” box 698 that behaves in the manner described with reference to box 690 and 692. In this regard, if a “human error” is associated with the failure mode displayed in GUI 500, then an identifier will appear in the box 698 to indicate such.

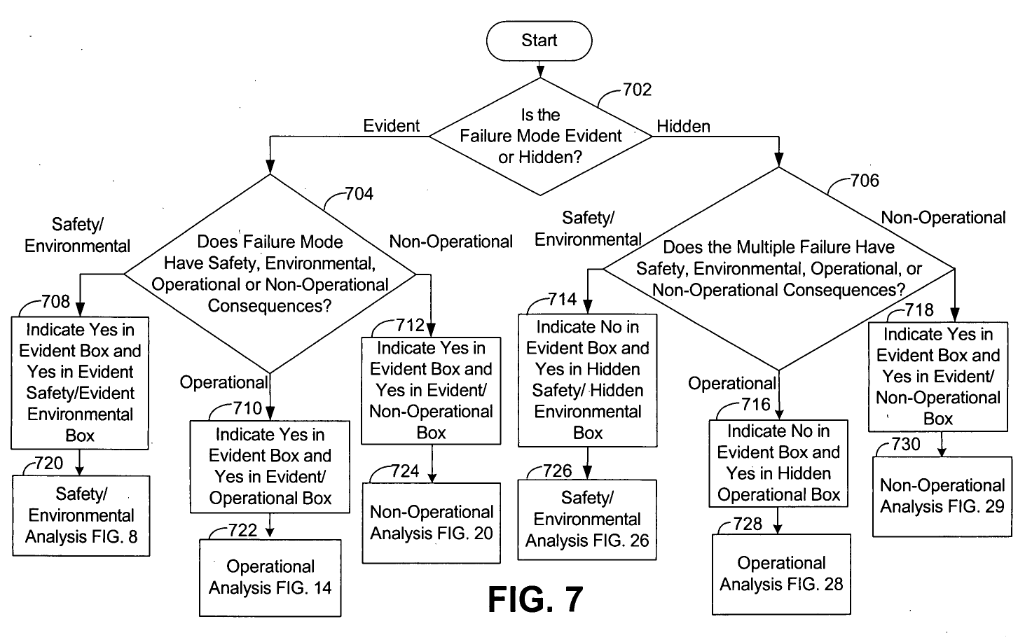

FIG. 7 is a flowchart depicting generally the RCM analysis performed by the RCM team using the GUI 600 of FIG. 6 by the RCM team.

The RCM team initially answers the question of whether the failure mode being analyzed is hidden or evident, in step 702. If the failure mode being analyzed is an evident failure, i.e., one that is recognizable or discernible by a maintenance person or a crewman during normal duties, the RCM team determines whether the failure mode has safety, environmental, operational, or non-operational consequences in step 704. Alternatively, if the failure mode being analyzed is a hidden failure, i.e., one that is not recognizable or discernible by a maintenance person or a crewman during normal duties, but is recognizable as a result of a multiple failure, the RCM team determines whether the multiple failure has safety, environmental, operational, or non-operational consequences in step 706.

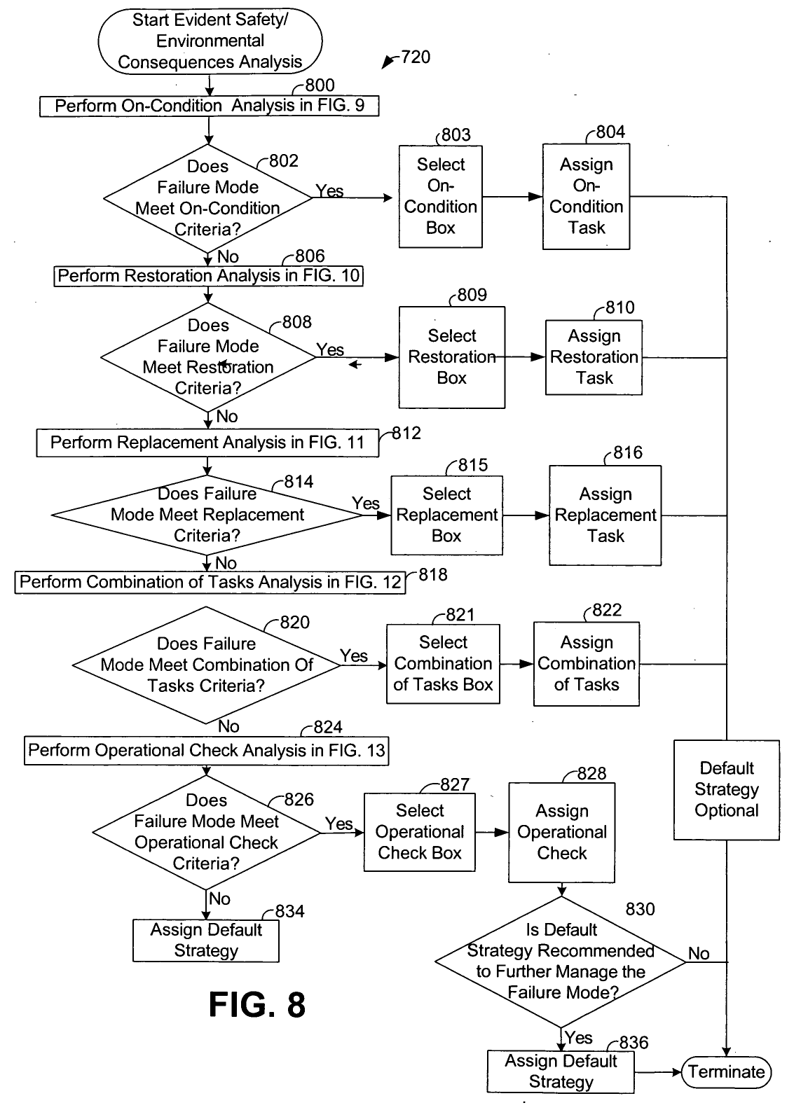

If the failure mode causes a loss of function or secondary damage that could have operational safety or environmental consequences in decisional step 704, then the facilitator indicates a “yes,” for example, the letter “Y,” in the evident/safety 619 (FIG. 6) or in the evident/environmental box 620 (FIG. 6), and environmental consequences, respectively, in step 708. When the facilitator 101 selects the evident box 618, the RCM logic 214 disables the hidden boxes 623-626. In this regard, an evident failure mode and a hidden failure mode are mutually exclusive. Therefore, the RCM logic 214 does not allow the facilitator 101 to select one of the hidden boxes 623-626 when the evident box 618 is selected. The RCM team performs the safety/environmental analysis in step 720, which is further described with reference to FIG. 8.

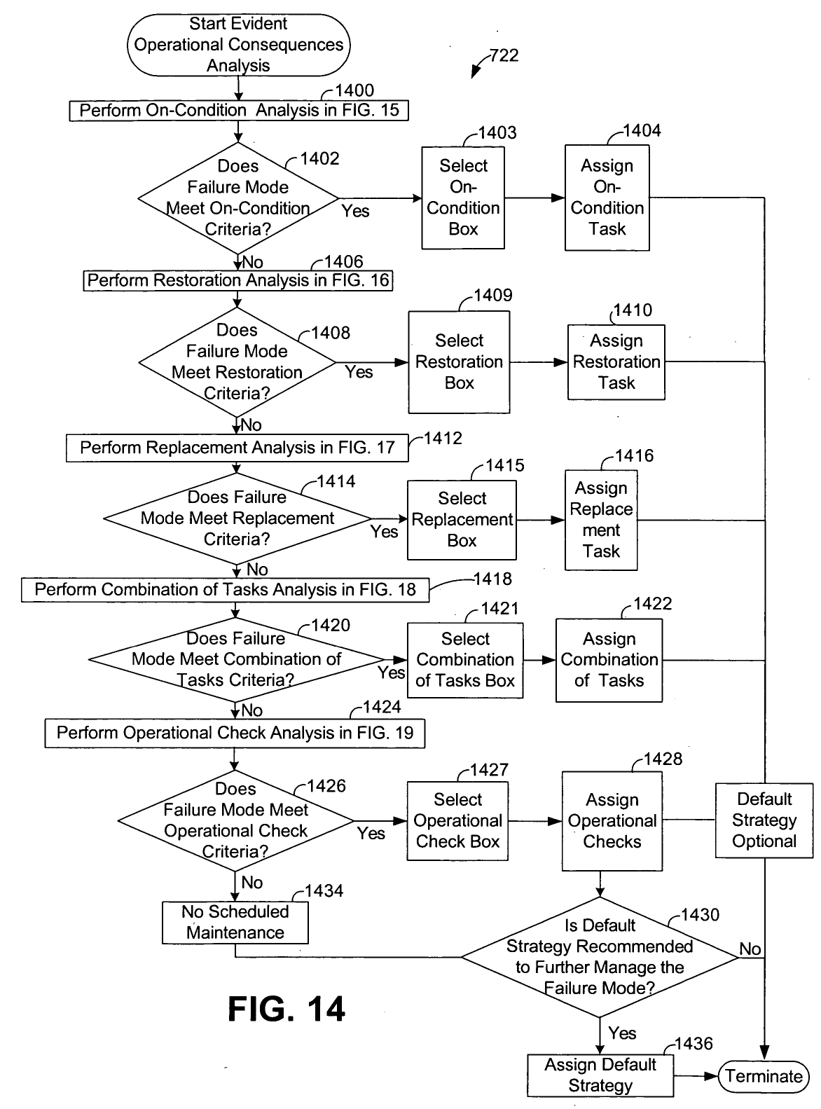

If the failure mode being analyzed is evident, i.e., one that is recognizable or discernible by a maintenance person or a crewman during normal duties, and the failure mode causes a loss of function or secondary damage that could has operational consequences in decisional step 704, then the facilitator 101 indicates a “yes,” for example, the letter “Y,” in the evident box 618 and the evident/operational box 621, in step 710. The RCM team performs the operational analysis in step 722, which is further described with reference to FIG. 14.

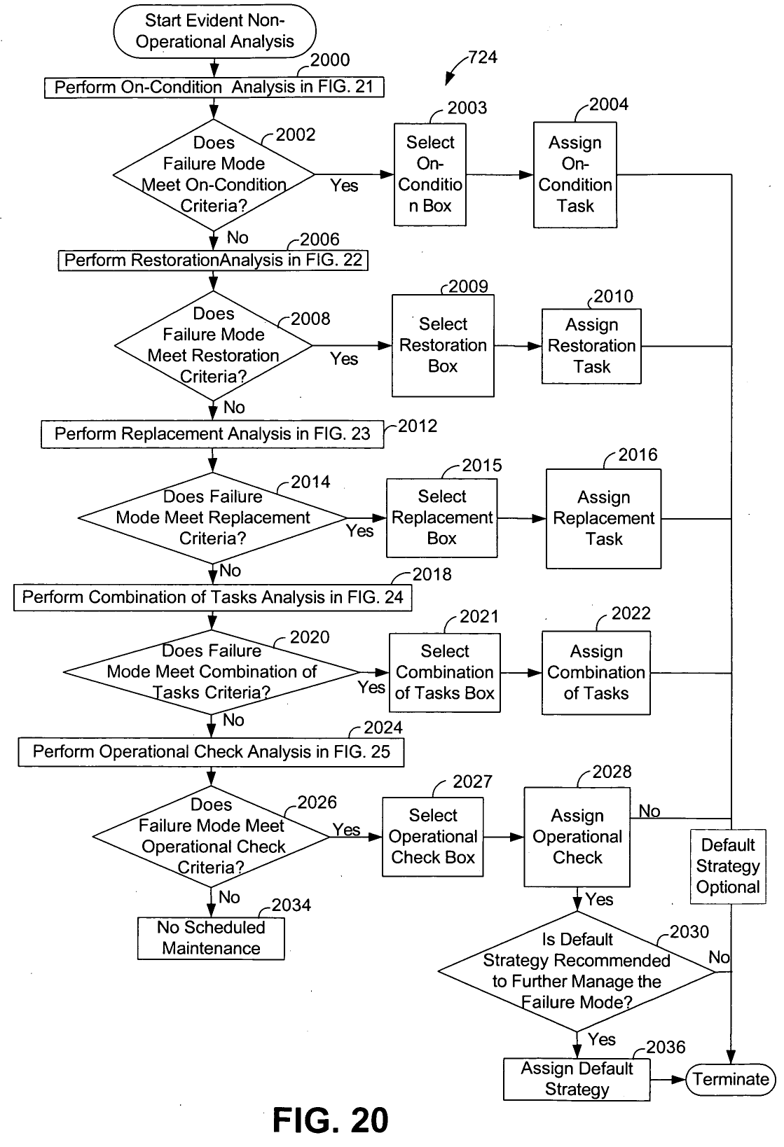

If the failure mode being analyzed is evident, i.e., one that is recognizable or discernible by a maintenance person or a crewman during normal duties, and the failure mode has non-operational consequences, i.e., does not affect safety, environment or operational functionality, in decisional step 704, then the facilitator indicates a “yes,” for example, the letter “Y,” in the evident box 618 and the evident/non-operational box 622, in step 712. The RCM team performs the non-operational analysis in step 724, which is further described with reference to FIG. 20.

If the failure mode being analyzed is hidden, i.e., one that is not recognizable or discernible by a maintenance person or a crewman during normal duties, the RCM team determines whether the multiple failure has safety, environmental, operational, or non-operational consequences. For example, the smoke detector is not working properly and there is a fire in the room, as described hereinabove.

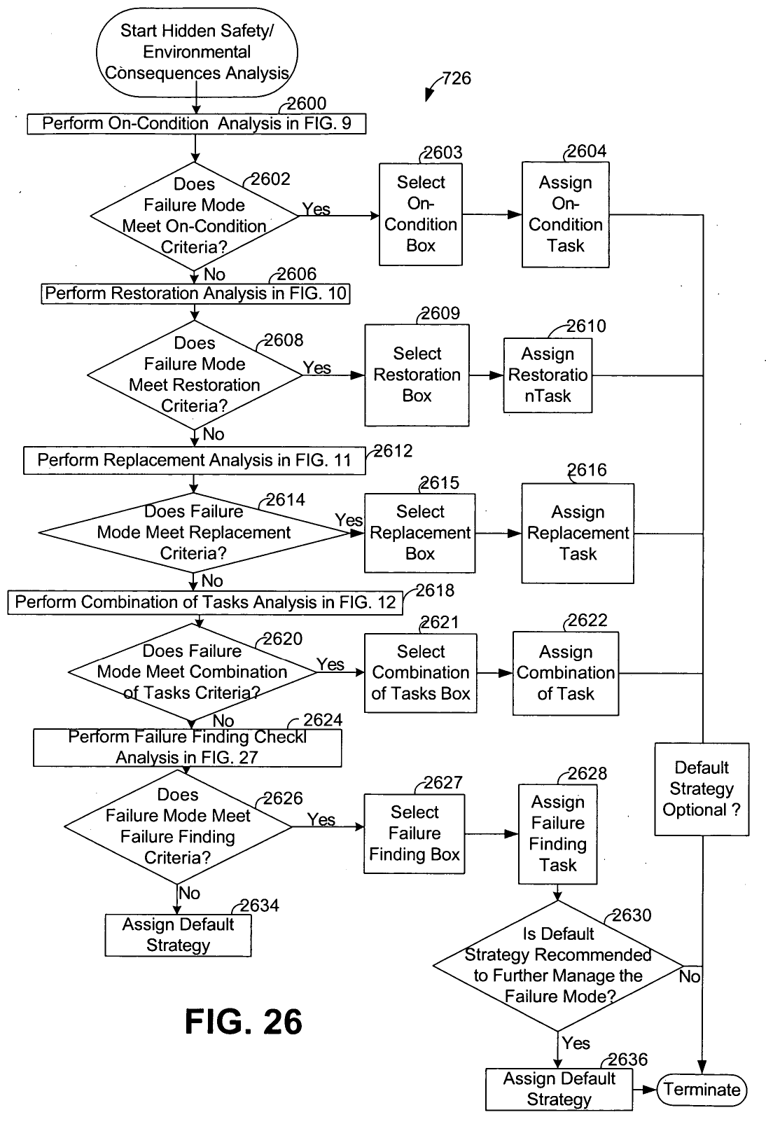

If the failure mode is hidden and the multiple failure mode has safety or environmental consequences in decisional step 706, then the facilitator indicates a “no,” for example, the letter “N,” in 618. Further, the facilitator indicates a “yes” in the hidden/safety box 623 (FIG. 6) if the hidden failure mode has safety consequences or a “yes” in the hidden/environmental box 624 if it is has environmental consequences, in step 714. If the multiple/failure affects safety or environment, the RCM team performs the hidden safety/environmental analysis in step 726, which is further described with reference to FIG. 26.

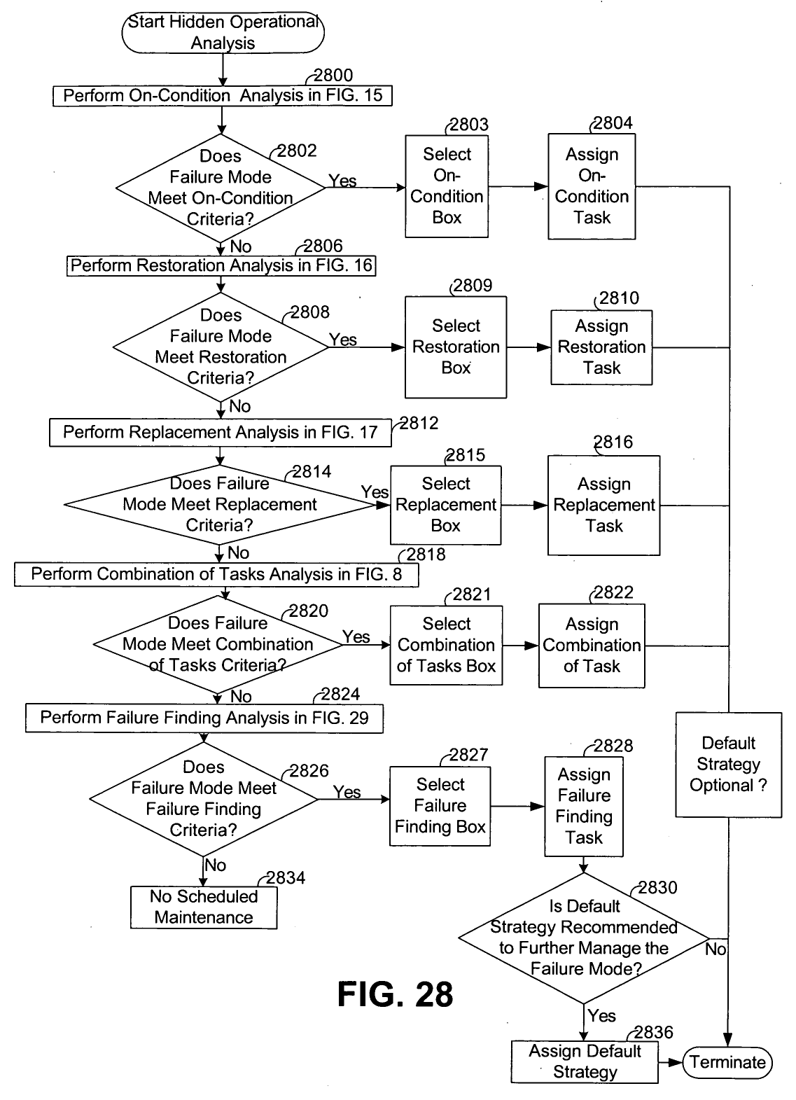

If the failure mode being analyzed is hidden, i.e., one that is not recognizable or discernible by a maintenance person or a crewman during normal duties, and the multiple/failure causes a loss of function or secondary damage that could have a direct adverse effect on operational functionality in decisional step 706, then the facilitator indicates a “yes,” for example, the letter “Y,” in the hidden/operational box 625, in step 716. Further, the RCM team performs the hidden operational analysis in step 728, which is further described with reference to FIG. 28.

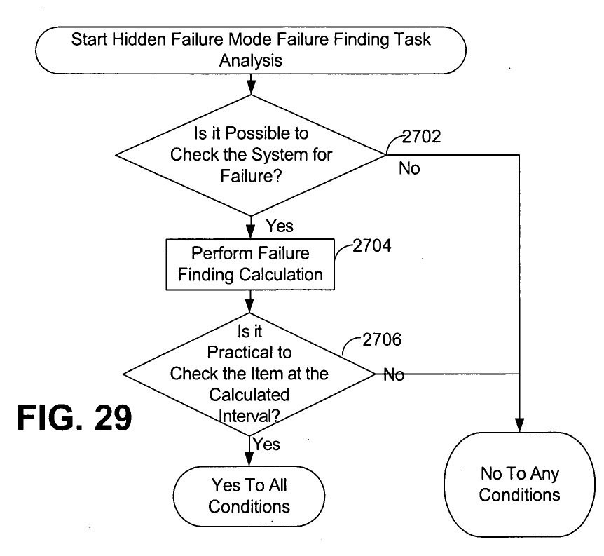

If the failure mode being analyzed is a hidden failure, i.e., one that is not recognizable or discernible by a maintenance person or a crewman during normal duties, and the multiple failure mode has non-operational consequences, i.e., does not have safety, environment or operational consequences, in decisional step 704, then the facilitator indicates a “yes,” for example, the letter “Y,” in the hidden/non-operational box 626, in step 718. The RCM team performs the non-operational analysis in step 730, which is further described with reference to FIG. 29.

FIG. 8 is a flowchart depicting the evident safety/environmental analysis performed by the RCM team using the GUI 600 of FIG. 6.

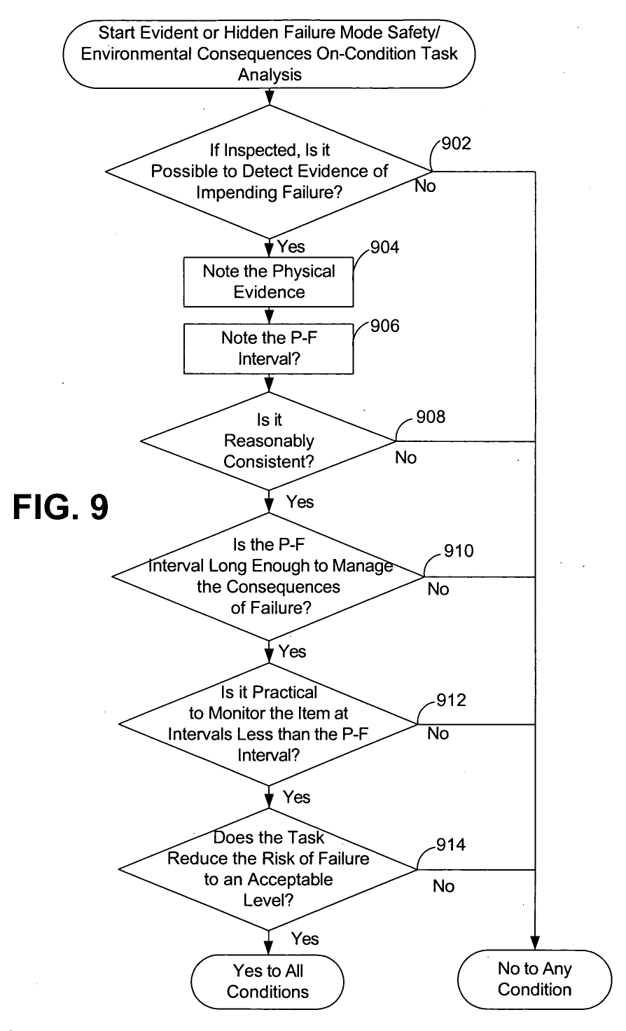

For each failure mode that has safety/environmental consequences and the failure mode being analyzed is evident as described hereinabove, the RCM team performs the evident safety/environmental analysis of FIG. 8. In this regard, the RCM team performs the on-condition task analysis in step 800 to determine if an on-condition task would appropriately manage the failure mode being analyzed. The on-condition task analysis is described in more detail with reference to FIG. 9. If the RCM team determines that the failure mode meets on-condition task criteria based upon the analysis in step 802, then the facilitator 101 selects the on-condition box 627 (FIG. 6) in step 803 and assigns an appropriate on-condition task to manage the failure mode, as indicated in step 804. In so assigning, the facilitator 101 enters data describing the task into the editable text box 652 (FIG. 6). The analysis with respect to the presently displayed failure mode in text box 612 (FIG. 6) is then complete.

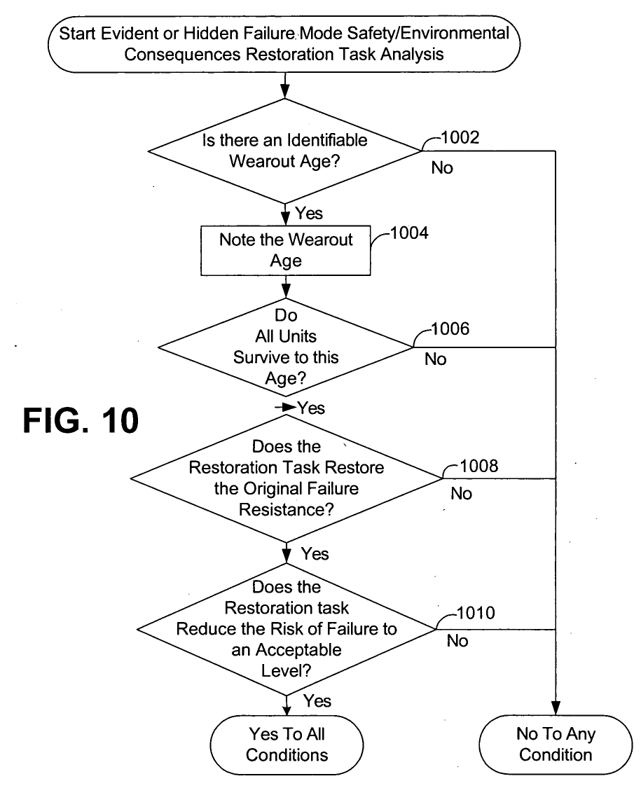

If the failure mode does not meet the on-condition task criteria in step 802, the RCM team performs a restoration task analysis in step 806, which is further described with reference to FIG. 10. If the RCM team determines that the failure mode meets the restoration task criteria, in step 808, then the facilitator 101 selects the restoration box 628 (FIG. 6) in step 809 and assigns an appropriate restoration task to manage the failure mode, as indicated in step 810. In so assigning, the facilitator enters data describing the task into the editable text box 652 (FIG. 6). The analysis with respect to the presently displayed failure mode in text box 612 (FIG. 6) is then complete.

If the failure mode does not meet the restoration analysis in step 808, then the RCM team performs a replacement task analysis in step 812, which is further described with reference to FIG. 1. If the RCM team determines that the failure mode meets the replacement task criteria, in step 814, then the facilitator 101 selects the replacement box 629 (FIG. 6) in step 815 and assigns an appropriate replacement task to manage the failure mode, as indicated in step 816. In so assigning, the facilitator enters data describing the task into the editable text box 652 (FIG. 6). The analysis with respect to the presently displayed failure mode in text box 612 (FIG. 6) is then complete.

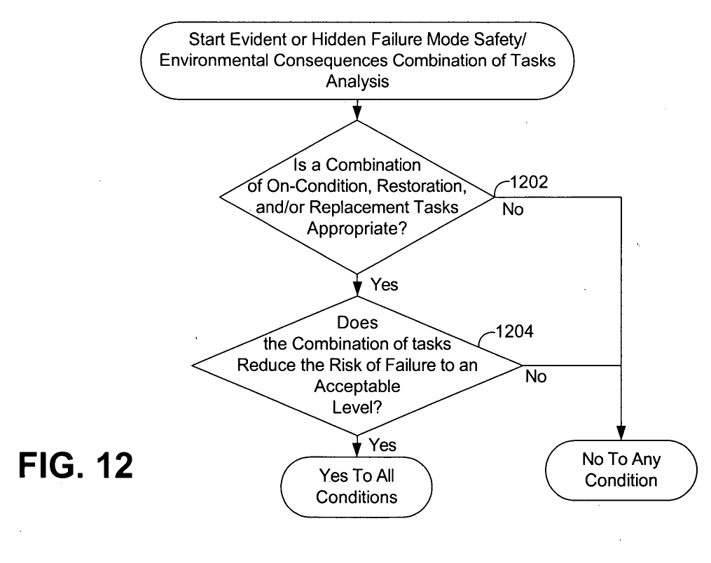

If the failure mode does not meet the replacement task criteria in step 814, then the RCM team performs a combination of tasks in step 818, which is further described with reference to FIG. 12. If the RCM team determines that the failure mode meets the combination of tasks criteria, in step 820, then the facilitator 101 selects the combination box 630 (FIG. 6) in step 821 and assigns an appropriate combination of tasks to manage the failure mode, as indicated in step 822. In so assigning, the facilitator preferably enters data describing the tasks into the editable text boxes 652 (FIG. 6). The analysis with respect to the presently displayed failure mode in text box 612 (FIG. 6) is then complete.

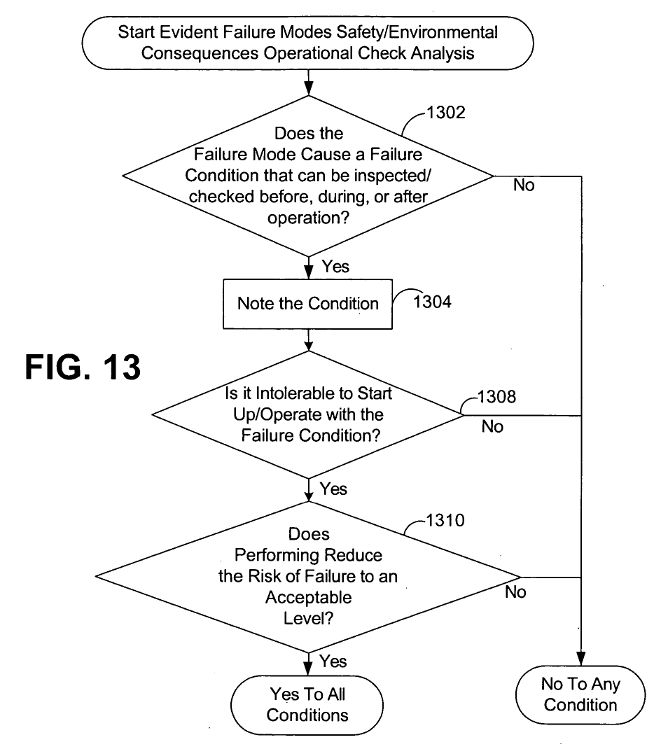

If the failure mode does not meet the combination of tasks criteria in step 820, then the RCM team performs an operational check analysis in step 824, which is further described with reference to FIG. 13. If the RCM team determines that the failure mode meets the operational check criteria, in step 820, then the facilitator 101 selects the default operational check box 631 (FIG. 6) in step 827 and assigns an appropriate default operational check to manage the failure mode, as indicated in step 828. In so assigning, the facilitator preferably enters data describing the task into the editable text box 652 (FIG. 6).

Once the operational check is assigned in step 828, the RCM team analyzes whether there is a default strategy that might aid in further managing the failure mode.

As described herein, a default strategy might encompass the RCM team providing revisions and/or additions to technical publications relating to the failure mode, creating engineering change reports for modifying equipment to better handle the failure mode, making changes to the operating procedure corresponding to the equipment, suggesting additional training on the equipment, and/or other appropriate measure that might further aid in managing the failure mode. If such analysis determines that a default strategy is recommended to further manage the failure mode, as indicated in step 830, the facilitator selects the default strategy box 633 and assigns a default strategy in step 836. The analysis with respect to the presently displayed failure mode in text box 612 (FIG. 6) is then complete.

If the failure mode does not meet the operational check, as indicated in step 826, then the RCM team assigns a default strategy as described hereinabove in step 834. As described, a default strategy is an action or combination of actions that may reduces the risk of failure to an acceptable level.

FIG. 9 is a flowchart depicting an exemplary on-condition task analysis for hidden failure modes that have safety/environmental consequences of step 800 (FIG. 8). In analyzing the failure mode to determine if an on-condition task is appropriate, the RCM team first determines whether it is possible to detect evidence of an impending failure in step 902.

If it is not possible to detect evidence of impending failure, then the failure mode can not be addressed with an on-condition task. However, if it is possible to detect evidence of impending failure in step 902, the facilitator 101 preferably elicits information from the RCM team to indicate the type of evidence in step 904, which the facilitator 101 might enter into the P-F Notes described hereinabove or some other appropriate data entry point in the GUI 600.

Further, the facilitator 101 elicits information from the RCM team regarding the P-F interval related to the failure mode in step 906. The facilitator 101 may enter such information in the P-F notes by selecting push button 668, and entering the information in the editable text box (not shown) that the RCM logic 214 displays when the P-F notes button is selected by the facilitator 101. As described hereinabove, the P-F interval describes the potential failure to failure time interval pertaining to a particular potential failure associated with the failure mode currently being analyzed.

Further, the RCM team determines whether the P-F interval associated with the failure mode that is currently displayed is reasonably consistent in its occurrence in step 908. If it is not reasonably consistent, then the failure mode can not be addressed with an on-condition task, and the on-condition task analysis terminates.

If, however, the P-F interval is reasonably consistent in step 908, then the RCM team determines whether the P-F interval associated with the failure mode is long enough to manage the consequences of failure in step 910. If it is not, then the failure mode can not be addressed with an on-condition task, and the on-condition task analysis terminates.

If, however, the interval is long enough, then the RCM team determines whether it is practical to monitor the equipment at intervals less than the P-F interval in step 912. If it is not, then the failure mode can not be addressed with an on-condition task, and the on-condition task analysis terminates.

If, however, it is practical to monitor at intervals less than the P-F interval in step 912, then the RCM team determines whether there is a task associated with the failure mode that reduces the risk of failure to an acceptable level (safety/environmental consequences) in step 914. If there is not, then the failure mode cannot be addressed with an on-condition task, and the on-condition task analysis terminates.

If, however, there is a task that would reduce the risk of the failure mode to an acceptable level (safety/environmental consequences), then the failure mode meets the on-condition task criteria in step 914. Note that each of the questions corresponding to the on-condition task analysis is answered affirmatively in order to determine that the failure mode meets the on-condition task criteria.

FIG. 10 is a flowchart depicting an exemplary evident safety/environmental restoration analysis of step 806 (FIG. 8). In analyzing the failure mode to determine a restoration task is appropriate, the RCM team first determines whether there is an identifiable wearout age to the failure mode that is being analyzed in step 1002.

If there is not an identifiable wearout age determined in step 1002, then the failure mode can not be addressed with a restoration management strategy. However, if there is an identifiable wearout age, the facilitator 101 preferably elicits information from the RCM team to indicate the wearout age in step 1004, which the facilitator 101 might enter into the useful life editable text box (not shown) by selecting on the “Useful Life button 669 (FIG. 6) described hereinabove or some other appropriate data entry point in the GUI 600 (FIG. 6).

Further, the RCM team determines whether all units associated with the proposed restoration survive to the wearout age determine in step 1006. If all units do not survive until the wearout age, then the failure mode can not be addressed with a restoration management strategy, and the restoration analysis terminates.

If, however, all units do survive to the wearout age, then the RCM team determines whether a restoration task will restore the original failure resistance in step 1008. If it will not, then the failure mode can not be addressed with a restoration management strategy, and the restoration analysis terminates.

If, however, the restoration task identified will restore the original failure resistance in step 1008, then the RCM team determines if an identified task reduces the risk of failure to an acceptable level. If it does not, then the failure mode can not be addressed with a restoration task, and the restoration analysis terminates.

If, however, there is a task that would reduce the risk to an acceptable level, then the failure mode meets the restoration task criteria in step 1010. Note that each of the questions corresponding to the restoration analysis must be answered affirmatively in order to determine that the failure mode meets the restoration task criteria.

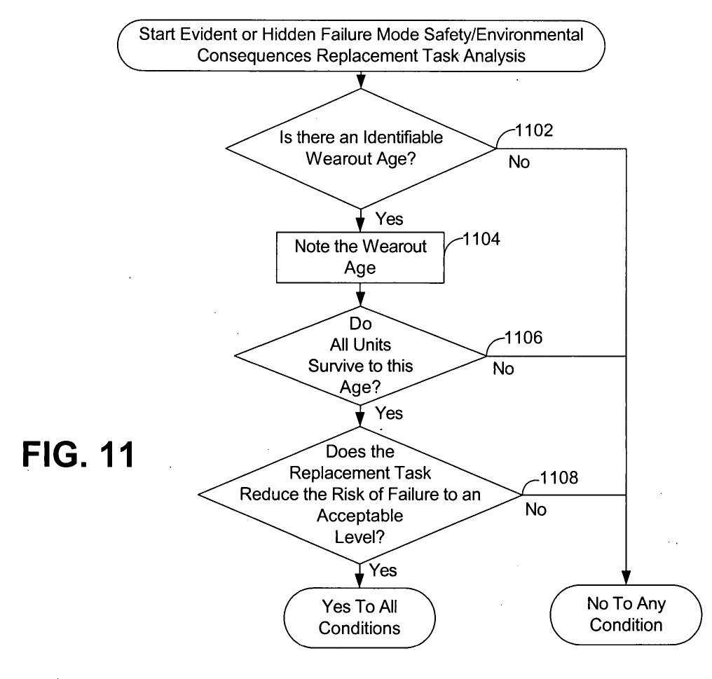

FIG. 11 is a flowchart depicting an exemplary replacement analysis of step 812 (FIG. 8). In analyzing the failure mode to determine if a replacement task is appropriate, the RCM team first determines whether there is an identifiable wearout age in step 1102.

If there is not an identifiable wearout age determined in step 1102, then the failure mode can not be addressed with a replacement task. However, if there is an identifiable wearout age in step 1102, the facilitator 101 preferably elicits information from the RCM team to indicate the wearout age in step 1104, which the facilitator 101 might enter into the useful life editable text box (not shown) by selecting on the Useful Life button 669 (FIG. 6) described hereinabove or some other appropriate data entry point in the GUI 600 (FIG. 6).

Further, the RCM team determines if all units associated with the proposed restoration survive to the wearout age determined in step 1106. If all units do not survive until the wearout age, then the failure mode is not a replacement failure mode, and the replacement analysis terminates.

If, however, all units do survive to the wearout age, then the RCM team determines whether a replacement task will reduce the risk of failure to an acceptable level in step 1108. If it will not, then the failure mode is not subject to a replacement task, and the replacement task analysis terminates.

If, however, the replacement will reduce the risk of failure to an acceptable level in step 1108, then the failure mode meets the replacement task criteria in step 1108. Note that each of the questions corresponding to the replacement analysis are preferably answered affirmatively in order to determine that the failure mode meets the replacement task criteria.

FIG. 12 is a flowchart depicting an exemplary combination of tasks analysis of step 818 (FIG. 8). In analyzing the failure mode to determine if a combination of tasks is appropriate, the RCM team determines whether there is a combination of on-condition, restoration and/or replacement tasks that are appropriate failure management strategies for the failure mode being analyzed in step 1202.

If there is not, then management of the failure mode can not be addressed with a combination of tasks. Therefore, the combination of tasks analysis terminates. If, however, there is a combination of tasks that is appropriate and the combination of tasks reduces the risk of failure to an acceptable level in step 1204, then the failure mode can be managed with a combination of on-condition tasks, restoration tasks, and/or replacement tasks. Note that each of the questions corresponding to the combination of tasks analysis is preferably answered affirmatively in order to determine that the failure mode meets the combination of tasks criteria.

FIG. 13 is a flowchart depicting an exemplary operational check analysis of step 824 (FIG. 8). In analyzing the failure mode to determine whether the failure mode can be managed with an operational check, the RCM team first determines whether the failure mode causes a failure condition that can be inspected/checked before, during, or after operation in step 1302.

If the failure mode does not cause a failure condition in step 1302, then the failure mode cannot be managed using an operational check. Thus, the operational check analysis terminates.

However, if the failure mode causes a failure condition, the facilitator 101 elicits information from the RCM team to indicate the condition in step 1304, which the facilitator 101 might enter into an editable text box (not shown) associated with the failure mode in the GUI 600.

If, however, it is considered intolerable to start up/operate with the failure condition in step 1308, then the RCM team determines if performing an operational check prior to or during operation reduces the risk of failure to an acceptable level. If it will not, then the failure mode is not manageable by an operational check, and the operational check analysis terminates.

If, however, a check prior to or during operation reduces the risk of failure to an acceptable level in step 1310, then the failure mode currently being analyzed can be managed using an operational check. Note that each of the questions corresponding to the operational check analysis are preferably answered affirmatively in order to determine that the failure mode meets the default operational criteria.

FIG. 14 is a flowchart generally depicting the analysis performed of evident failure modes that have operational consequences by the RCM team using the GUI 600 of FIG. 6.

As indicated, the analysis performed by the RCM team in accordance with analyzing a failure mode under the operational consequences analysis is similar to the analysis with respect to the safety/environmental analysis described with reference to FIG. 8. In this regard, in the basic flowchart in FIG. 14 a default strategy is not automatically assigned, instead no scheduled maintenance is determined in step 1434, and the RCM teams analyzes whether a default strategy is recommended to further manage the failure mode in step 1430. If a default strategy is recommended, the RCM team assigns a default strategy in step 1436. If no default strategy is recommended, then or for evident or hidden failure modes with operational consequences the evident operational analysis is. complete.

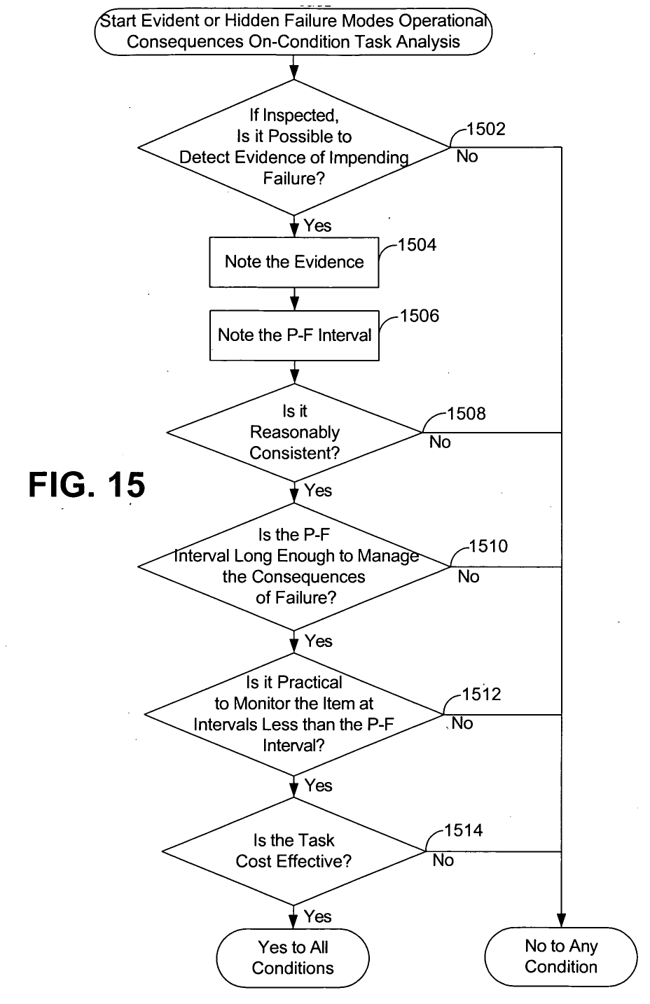

Additionally, when performing the on-condition task analysis in step 1500, such analysis is slightly different. FIG. 15 is a flowchart illustrating an on-condition task analysis performed by the RCM team or evident or hidden failure modes with operational consequences. When performing this on-condition task analysis, the inquiry in step 1514 is different with respect to the safety/environmental on-condition task analysis of FIG. 9. In this regard, the inquiry is whether the task is cost effective in step 1514. If the previous inquiries in steps 1508, 1510, and 1512 produce an affirmative response, and step 1514 is an affirmative response, then the failure mode being analyzed under the on-condition task analysis can be managed using an on-condition task.

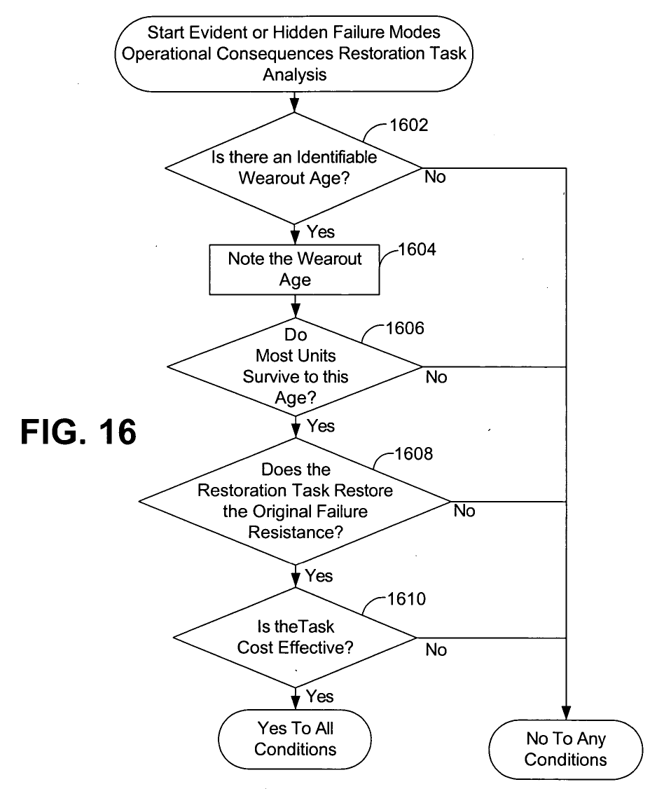

FIG. 16 is a flowchart illustrating restoration task analysis performed by the RCM team during restoration task analysis for failure modes that are hidden or evident and have operational consequences. When performing a restoration analysis in, the inquiry in step 1610 is different with respect to the safety/environmental restoration analysis of FIG. 10. In this regard, the inquiry is whether the task is cost effective step 1610. If the previous inquiries in steps 1602, 1606, and 1608 produce an affirmative response, and step 1610 is an affirmative response, then the failure mode being analyzed can be managed using a restoration task.

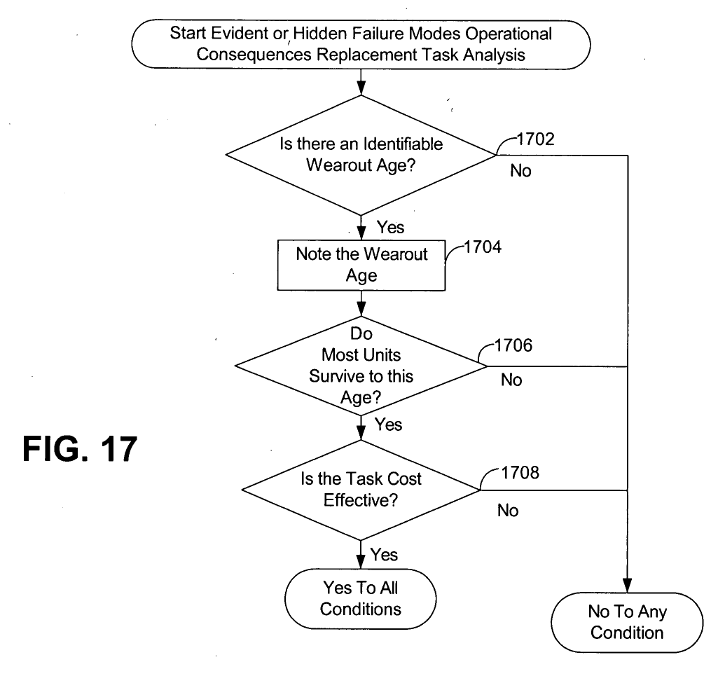

FIG. 17 is a flowchart illustrating a replacement task analysis performed by the RCM team or evident or hidden failure modes with operational consequences.

When performing the replacement task analysis, the inquiry in step 1708 is different with respect to the safety/environmental replacement task analysis of FIG. 11. In this regard, the inquiry is whether the task is cost effective in step 1708. If the previous inquiries in steps 1702 and 1706 produced an affirmative response, and step 1708 produces an affirmative response, then the failure mode being analyzed can be addressed using a replacement task.

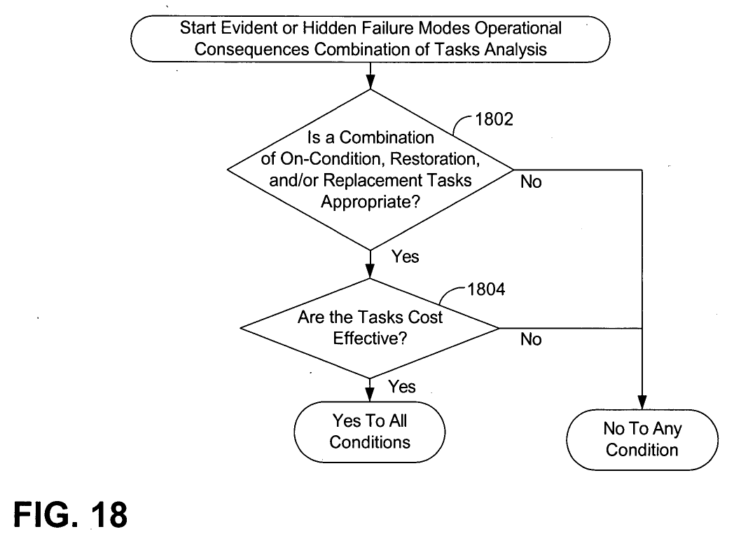

FIG. 18 is a flowchart illustrating a combination of tasks analysis performed by the RCM team on evident and hidden failure modes with operational consequences. When performing a combination of tasks analysis, the inquiry in step 1804 is different with respect to the safety/environmental combination of tasks analysis of FIG. 12. In this regard, the inquiry is whether the task is cost effective in step 1804. If the previous inquiry in step 1802 produces an affirmative response, and step 1804 produces an affirmative response, then the failure mode being analyzed under the operational analysis can be addressed using a combination of tasks.

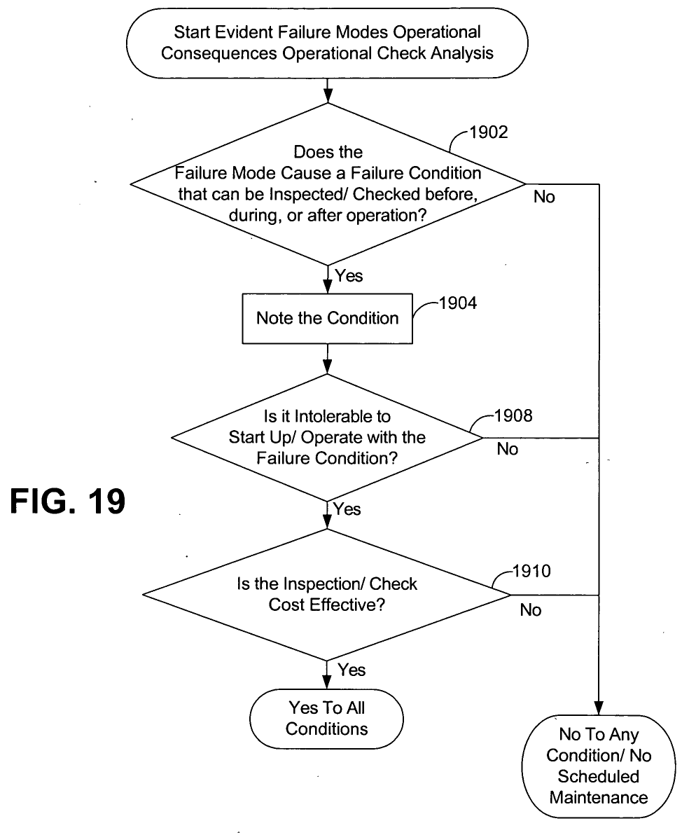

FIG. 19 is a flowchart illustrating an operational check analysis performed by the RCM team on evident failure modes with operational consequences. When performing an operational check analysis, the inquiry in step 1910 is different with respect to the safety/environmental operational check analysis of FIG. 13. In this regard, the inquiry is whether the task is cost effective in step 1910. If the previous inquiries in steps 1902, and 1908 produces an affirmative response, and step 1910 produces an affirmative response, then the failure mode being analyzed under the operational check analysis can be addressed using an operational check.

FIG. 20 is a, flowchart generally depicting the non-operational analysis for evident failure modes performed by the RCM team using the GUI 600 of FIG. 6.

As indicated, the analysis performed by the RCM team in accordance with analyzing an evident failure mode under the non-operational analysis is similar to the analysis with respect to the safety/environmental analysis described with reference to FIG. 8. In this regard, in the basic flowchart in FIG. 20, a default strategy is not automatically assigned, instead no scheduled maintenance is determined in step 2034, and the RCM team analyzes whether a default strategy is recommended to further manage the failure mode in step 2030. If a default strategy is recommended, the RCM team assigns a default strategy in step 2036.

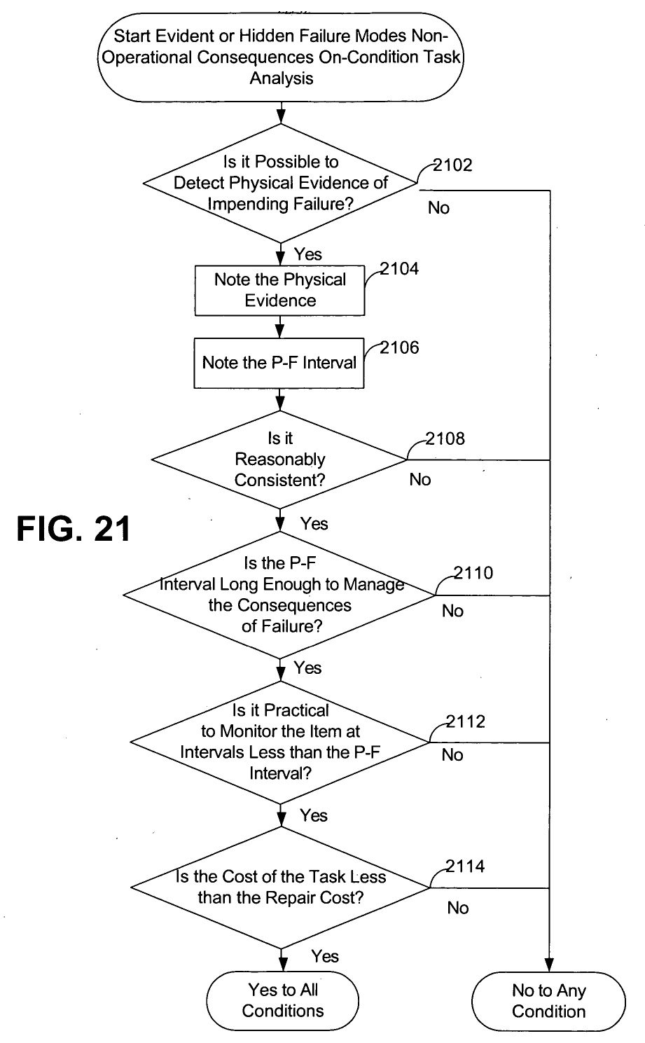

Additionally, when performing the evident, non-operational on-condition task analysis in step 2000, such analysis is slightly different than the safety/environmental on-condition task analysis. FIG. 21 is a flowchart illustrating an on-condition task analysis on evident or hidden failure modes with non-operational consequences performed by the RCM team. When performing an evident or hidden non-operational consequences on-condition task analysis, the inquiry in step 2114 is different with respect to the safety/environmental on-condition task analysis of FIG. 9. In this regard, the inquiry is whether the cost of the task is less than the repair costs in step 2114. If the previous inquiries in steps 2102, 2108, 2110, and 2112 produce an affirmative response, and step 2114 produces an affirmative response, then the failure mode being analyzed can be addressed with an on-condition task.

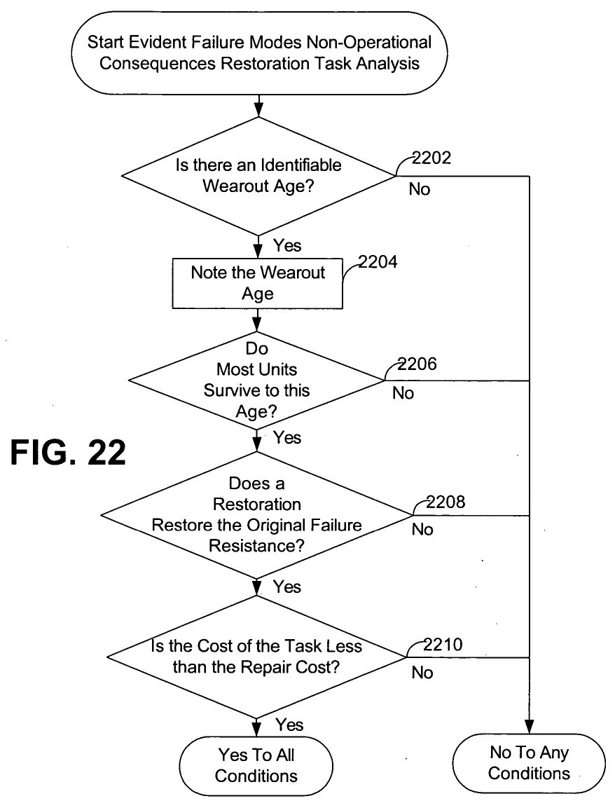

FIG. 22 is a flowchart illustrating a restoration analysis on evident failure modes with non-operational consequences performed by the RCM team. When performing a restoration task analysis in reference to an evident non-operational failure mode, the inquiry in step 2210 is different with respect to the safety/environmental restoration analysis of FIG. 10. In this regard, the inquiry is whether the cost of the task is less than the repair cost in step 2210. If the previous inquiries in steps 2202, 2206, and 2208 produce an affirmative response, and step 2210 produces an affirmative response, then the failure mode being analyzed can be managed with a restoration task.

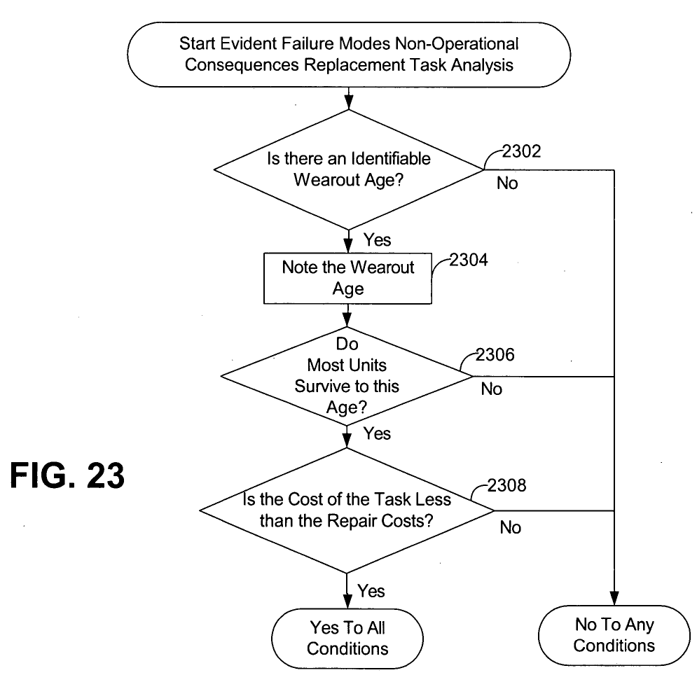

FIG. 23 is a flowchart illustrating a replacement task analysis on evident failure modes with non-operational consequences performed by the RCM team during a non-operational analysis. When performing a replacement task analysis in reference to an evident non-operational failure mode, the inquiry in step 2308 is different with respect to the safety/environmental replacement task analysis of FIG. 11. In this regard, the inquiry is whether the cost of the task is less than the repair cost in step 2308. If the previous inquiries in steps 2302 and 2306 produce an affirmative response, and step 2208 produces an affirmative response, then the failure mode being analyzed can be addressed using a replacement task.

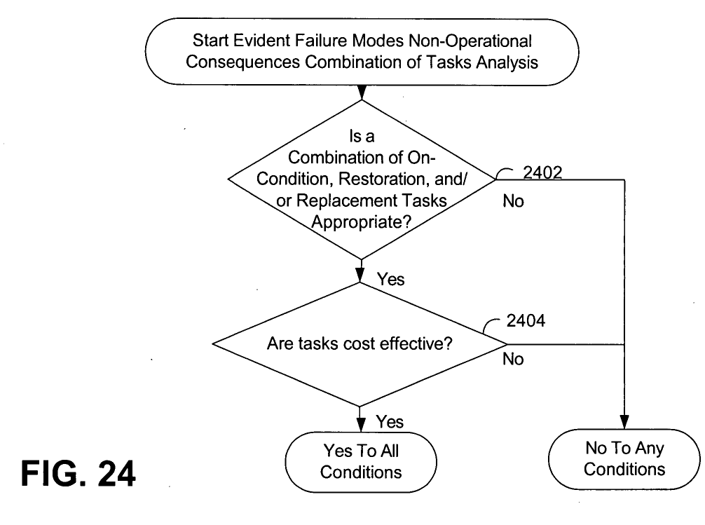

FIG. 24 is a flowchart illustrating a combination of tasks analysis on evident failure modes with non-operational consequences performed by the RCM team.

When performing a combination of tasks analysis in reference to an evident non-operational failure mode, the inquiry in step 2404 is different with respect to the safety/environmental combination of tasks analysis of FIG. 12. In this regard, the inquiry is whether the tasks are cost effective in step 2404. If the previous inquiry in step 2402 produces an affirmative response, and step 2404 produces an affirmative response, then the failure mode being analyzed can be addressed using a combination of tasks.

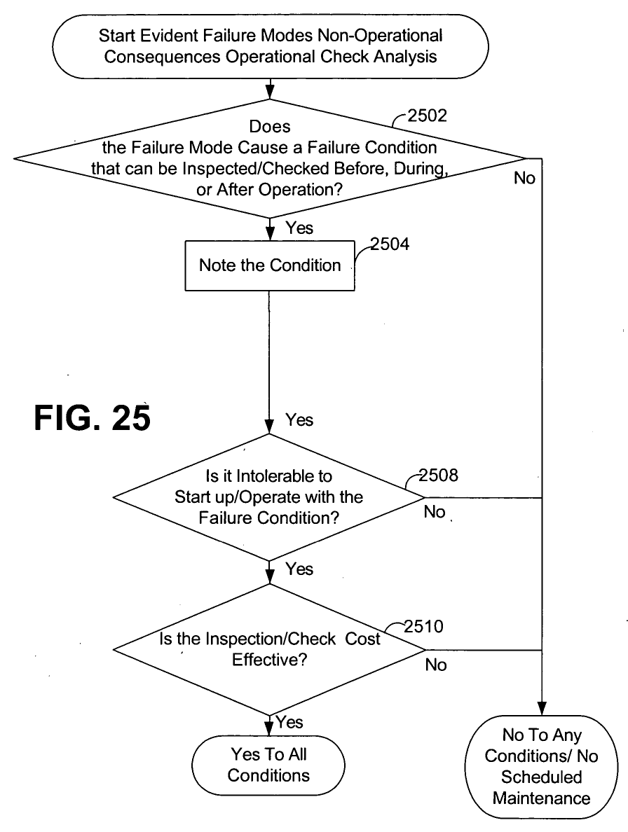

FIG. 25 is a flowchart illustrating an operational check analysis on evident failure modes with non-operational consequences performed by the RCM team. When performing an operational check analysis in reference to an evident non-operational failure mode, the inquiry in step 2510 is different with respect to the safety/environmental operational check analysis of FIG. 13. In this regard, the inquiry is whether the cost of the inspection/check is cost effective in step 2510. If the previous inquiries in steps 2502, and 2508 produce an affirmative response, and step 2510 produces an affirmative response, then the failure mode being analyzed can be addressed using an operational check.

FIG. 26 is a flowchart depicting the analysis on hidden failure modes with safety/environmental consequences performed by the RCM team using the GUI 600 of FIG. 6.

For each hidden failure mode that has safety/environmental consequences as defined hereinabove, the RCM team performs the hidden safety/environmental analysis of FIG. 26. In this regard, the RCM team appropriately manages the failure mode being analyzed. The on-condition task analysis is described in more detail with reference to FIG. 9, which is described hereinabove. Note that such on-condition task analysis is preferably identical to that analysis performed for evident failures having safety or environmental consequences.

If the RCM team determines that the failure mode meets on-condition task criteria based upon the analysis in step 2600, then the facilitator 101 selects the on-condition box 627 (FIG. 6) in step 2603 and assigns an appropriate on-condition task to manage the failure mode, as indicated in step 2604. In so assigning, the facilitator 101 enters data describing the task into the editable text box 652 (FIG. 6). The analysis with respect to the presently displayed failure mode in text box 612 (FIG. 6) is then complete.

If the failure mode does not meet the on-condition task criteria in step 2602, the RCM team performs a restoration task analysis in step 2606, which is further described with reference to FIG. 10. Further note that the hidden failure mode restoration task analysis with safety/environmental consequences is also identical to the evident failure mode restoration task analysis.

If the RCM team determines that the failure mode meets the restoration task criteria, in step 2608, then the facilitator 101 selects the restoration box 628 (FIG. 6) in step 2609 and assigns an appropriate restoration task to manage the failure mode, as indicated in step 2610. In so assigning, the facilitator preferably enters data describing the task into the editable text box 652 (FIG. 6). The analysis with respect to the presently displayed failure mode in text box 612 (FIG. 6) is then complete.

If the failure mode does not meet the restoration analysis in step 2608, then the RCM team performs a replacement task analysis in step 2612, which is further described with reference to FIG. 11. Note that the hidden failure mode restoration tasks analysis is also identical to the evident failure mode restoration tasks analysis.

If the RCM team determines that the failure mode meets the replacement task criteria, in step 2614, then the facilitator 101 selects the replacement box 629 (FIG. 6) in step 2615 and assigns an appropriate replacement task to manage the failure mode, as indicated in step 2616. In so assigning, the facilitator preferably enters data describing the task into the editable text box 652 (FIG. 6). The analysis with respect to the presently displayed failure mode in text box 612 (FIG. 6) is then complete.

If the failure mode does not meet the replacement task analysis criteria in step 2614, then the RCM team performs a combination of tasks analysis in step 2618, which is further described with reference to FIG. 12. Note that the hidden failure mode with safety/environmental consequence combination of task analysis is also identical to the evident failure mode with safety/environmental consequence combination of task analysis.

If the RCM team determines that the failure mode meets the combination of tasks criteria, in step 2620, then the facilitator 101 selects the combination box 630 (FIG. 6) in step 2621 and assigns an appropriate combination of tasks to manage the failure mode, as indicated in step 2622. In so assigning, the facilitator preferably enters data describing the task into the editable text box 652 (FIG. 6). The analysis with respect to the presently displayed failure mode in text box 612 (FIG. 6) is then complete.

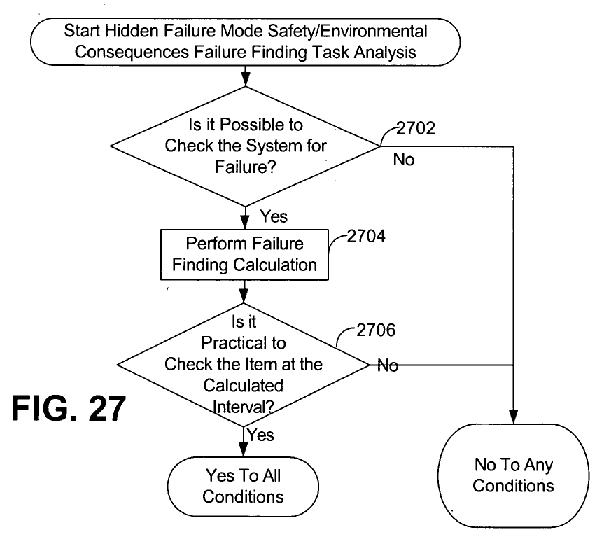

If the failure mode does not meet the combination of tasks analysis criteria in step 2618, then the RCM team performs a failure finding check analysis in step 2624, which is further described with reference to FIG. 27.

If the RCM team determines that the failure mode meets the failure finding criteria, in step 2626, then the facilitator 101 selects the failure finding check box 632 (FIG. 6) in step 2627 and assigns an appropriate failure finding task to manage the failure mode, as indicated in step 2628. In so assigning, the facilitator preferably enters data describing the task into the editable text box 652 (FIG. 6).

Once the failure finding task is assigned in step 2628, the RCM team analyzes whether there is a default strategy that might aid in further managing the failure mode.

As described herein, a default strategy might encompass the RCM team providing revisions and/or additions to technical publications relating to the failure mode, creating engineering change reports for modifying equipment to better handle the failure mode, making changes to the operating procedure corresponding to the equipment, suggesting additional training on the equipment, and/or other appropriate measure that might further aid in managing the failure mode. If such analysis determines that a default strategy is recommended to further manage the failure mode, as indicated in step 2630, the facilitator selects the default strategy box 633 and assigns a default strategy in step 2636. The analysis with respect to the presently displayed failure mode in text box 612 (FIG. 6) is then complete.

If the failure mode does not meet the failure finding check criteria, as indicated in step 2626, then the RCM team assigns a default strategy as described hereinabove in step 2634.

FIG. 27 is a flowchart depicting an exemplary failure finding check analysis of step 2624 (FIG. 26). In analyzing the failure mode to determine whether the multiple failure can be managed with a failure finding check, the RCM team first determines whether it is possible to check the system for failure in step 2702.

If it is not feasible to check the system for the failure in step 2702, then the hidden failure mode cannot be managed using a failure finding check. Thus, the failure finding check analysis terminates.

However, if it is feasible to check the system for failure in step 2702, the RCM team then performs a failure finding calculation in step 2704. Such failure finding by the RCM team determines an interval corresponding to the calculation.

Further, the RCM team determines whether it is practical to check the item at the calculated interval in step 2706. If it is not practical, then the failure mode cannot be managed with a failure finding check, and the failure finding check analysis terminates.

If, however, it is practical to check the item at the calculated interval, the hidden failure mode currently being analyzed can be managed using a failure finding check. Note that each of the questions corresponding to the failure finding check analysis are preferably answered affirmatively in order to determine that the failure mode meets the failure finding check criteria. In this regard, the facilitator selects button 632 (FIG. 6).

FIG. 28 is a flowchart depicting an exemplary analysis on hidden failure modes with operational consequences performed by the RCM team using the GUI 600 of FIG. 6. For each hidden failure mode that has operational consequences as defined hereinabove, the RCM team performs the hidden operational consequences analysis of FIG. 28.

Such analysis is substantially the same as the hidden safety/environmental consequences analysis of FIG. 26. However, in step 2834, no maintenance is scheduled if the failure mode can not be addressed using on-condition, restoration, replacement, combination of tasks, or failure finding. Instead, the RCM team determines whether a default strategy is recommended to manage the failure mode in step 2830. If a default strategy is recommended, the RCM team assigns a default strategy in step 2836, and the analysis terminates.

FIG. 29 is a flowchart depicting an exemplary failure finding check analysis of step 2824 (FIG. 28). In analyzing the failure mode to determine whether the multiple failure can be managed with a failure finding check, the RCM team first determines whether it is possible to check the system for failure in step 2702.

If it is not feasible to check the system for the failure in step 2702, then the hidden failure mode cannot be managed using a failure finding check. Thus, the failure finding check analysis terminates and no maintenance is scheduled.

However, if it is feasible to check the system for failure in step 2702, the RCM team then performs a failure finding calculation in step 2704.

Further, the RCM team determines whether it is practical to check the item at the calculated interval in step 2706. If it is not practical, then the failure mode cannot be managed with a failure finding check, and the failure finding check analysis terminates.

If, however, it is practical to check the item at the calculated interval, the hidden failure mode currently being analyzed can be managed using a failure finding check. Note that each of the questions corresponding to the failure finding check analysis are preferably answered affirmatively in order to determine that the failure mode meets the failure finding check criteria. In this regard, the facilitator selects button 632 (FIG. 6).

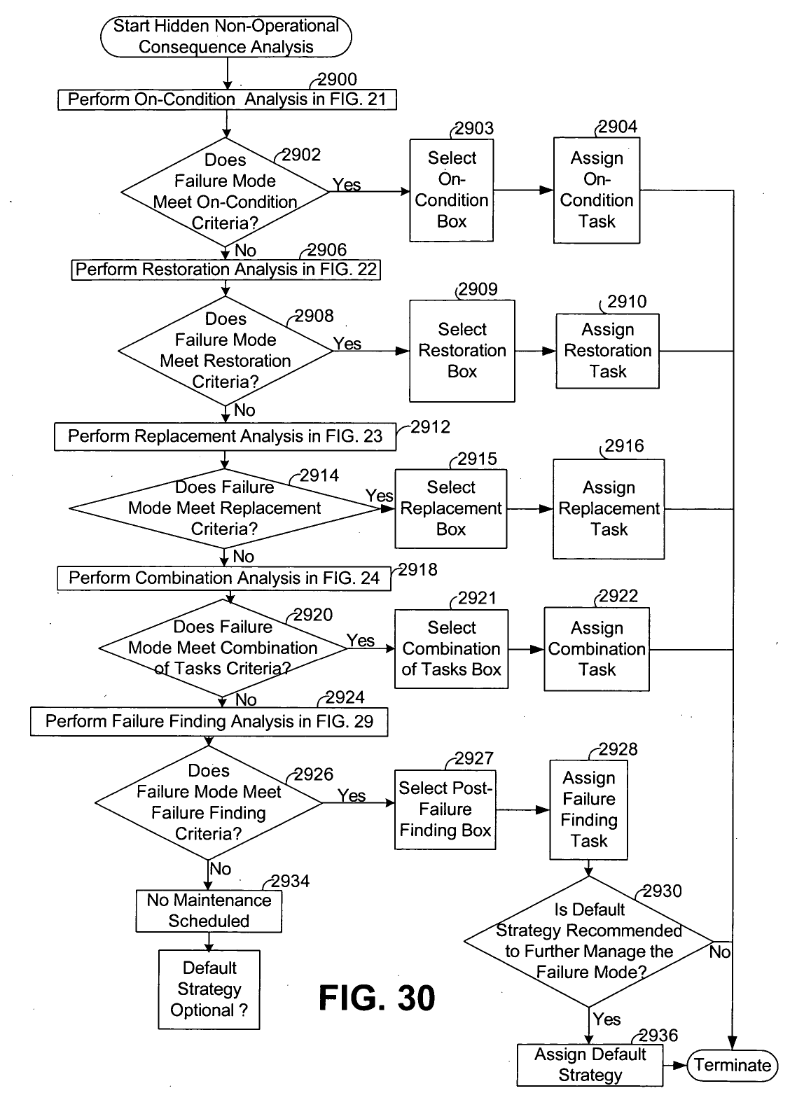

FIG. 30 is a flowchart depicting the analysis of hidden failure modes with non-operational consequences performed by the RCM team using the GUI 600 of FIG. 6.

For each hidden failure mode that has non-operational consequences as defined hereinabove, the RCM team performs the hidden non-operational consequence analysis of FIG. 30. Such analysis is substantially the same as the hidden operational analysis described with reference to FIG. 28.

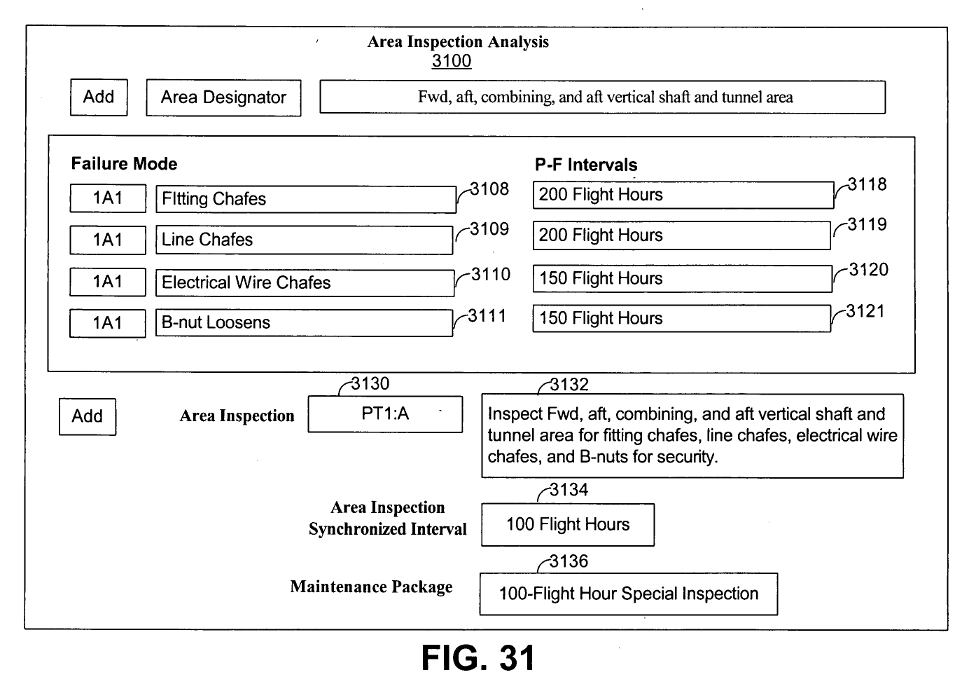

FIG. 31 depicts an area inspection GUI 3100 of an embodiment of the present disclosure, if the facilitator 101 selects the “Area Inspection” pushbutton 3818 (FIG. 4A). In this regard, the RCM logic 214 (FIG. 2) displays to the display device 210 (FIG. 2) and the visual device 110 (FIG. 1) via the projection device 212 (FIG. 2) the GUI 3100.

In one embodiment, the scope of the analysis of the RCM process is broken up into distinct areas, and the facilitator 101 and the RCM team provides data to the RCM device 107 corresponding to the area under inspection. FIG. 31 depicts a plurality of failure modes 3108-3111 corresponding to a plurality of P-F intervals 3118-3121 associated with a particular area, e.g., “Fwd, aft, combining, and aft vertical shaft and tunnel area.” Such failure mode data and P-F interval data entered via the GUI 500 (FIG. 5) and GUI 600 (FIG. 6).

Thus, in the area inspection analysis performed by the facilitator 101 and the RCM team via the GUI 3100, an area inspection is either generated or retrieved, e.g., area inspection “PT1:A” identified in a text box 3130 corresponding to a description of what is to be accomplished for the inspection in text box 3132. Furthermore, when considering the failure modes 3108-3111 and their associated P-F intervals 3118-3121, an area inspection synchronized interval is entered into a text box 3134. In this regard, the synchronized interval is going to related to the time between each of the area inspections identified. Furthermore, a maintenance package in which the inspection is to be placed is entered in a text box 3136.

1. A reliability centered maintenance system, comprising:
an input device; and
logic configured to receive and store data indicative of a function, a functional failure, a failure mode, and a failure effect, via the input device, the logic further configured to display the received data to a display device in response to a first user input and display a plurality of logical selectable input boxes corresponding to a type of the failure mode and at least one task or default strategy for addressing the failure mode, the logic further configured to receive at least one selection input via the selectable input boxes and receive data describing the at least one task or the at least one default strategy.

2. The system of claim 1, further comprising a projection screen, the logic configured to display the data and the input boxes to the projection screen and the display device simultaneously.

3. The system of claim 2, wherein the logic is configured to enlarge the data displayed to the screen in response to a second user input.

4. The system of claim 1, wherein the plurality of selectable input boxes comprises a portion of boxes for indicating hidden failure modes.

5. The system of claim 4, wherein the portion of selectable input boxes comprises a box configured for indicating an on-condition task, a restoration task, a replacement task, an operational check, or a combination of tasks associated with the failure mode.

6. The system of claim 1, wherein the plurality of selection input boxes comprises a portion of boxes for indicating evident failure modes.

7. The system of claim 6, wherein the portion of selectable input boxes comprises a box configured for indicating an on-condition task, a restoration task, a replacement task, an operational check, or a combination of tasks associated with the failure mode.

8. The system of claim 1, wherein the logic is further configured to receive, via the input device, data indicative of a time interval associated with performing the at least one task.

9. The system of claim 8, wherein the logic is further configured to receive, via the input device, data indicative of a maintenance package corresponding to the time interval.

10. The system of claim 9, wherein the logic is configured to generate a report comprising data indicative of the at least one task or default strategy.

11. The system of claim 1, further comprising a pushbutton that when selected receives data corresponding to information obtained after an analysis has been performed.

12. The system of claim 1, wherein at least one of the selectable input boxes indicates that a combination of tasks is appropriate for addressing the failure mode, and the logic is further configured to receive data indicative of a plurality of tasks associated with the combination of tasks.

13. The system of claim 1, wherein the logic is further configured to receive data indicative of an action item to be performed in association with the failure mode.

14. The system of claim 1, wherein the logic is further configured to receive data indicative of additional information that may be needed in order to further analyze the failure mode.

15. The system of claim 1, wherein the logic is further configured to receive data indicating that the failure mode is to be identified for an audit process.

16. The system of claim 16, wherein the logic is further configured to receive data indicative of a date for the audit process, members of an audit team, or a date of an RCM analysis corresponding to the failure mode.

17. The system of claim 1, wherein the logic is further configured to receive mode remark data indicative of additional information related to the failure mode.

18. The system of claim 1, wherein one of the selectable input boxes indicates that a human error may have been involved with the failure mode.

19. A reliability centered maintenance method, comprising:
receiving data indicative of a function, a functional failure, a failure mode, and a failure effect;
storing the data in memory;
displaying the data received in the receiving step to a display device in response to a first user input;
displaying a plurality of logical selectable input boxes corresponding to a type of the failure mode;
receiving data indicative of at least one task for addressing the failure mode;
receiving at least one selection input via the selectable input boxes;
receiving data describing the at least one task; and
storing in memory data indicative of the at least one task, the failure mode type, and the selection input for the failure mode.

20. The method of claim 19, further comprising displaying the data and the input boxes to the projection screen and the display device simultaneously.

21. The method of claim 20, enlarging the data displayed to the screen in response to a second user input.

22. The method of claim 19, further comprising displaying a portion of the plurality of selectable input boxes corresponding to hidden failure modes.

23. The method of claim 22, displaying the portion of the plurality of selectable input boxes corresponding to an on-condition task, a restoration task, a replacement task, an operational check, or a combination of tasks associated with the failure mode.

24. The method of claim 19, further comprising displaying a portion of the plurality of selectable input boxes corresponding to evident failure modes.

25. The method of claim 24, further comprising displaying the portion of the plurality of selectable input boxes corresponding to an on-condition task, a restoration task, a replacement task, an operation check, or a combination of tasks associated with the failure mode.

26. The method of claim 19, further comprising receiving, via the input device, data indicative of a time interval associated with performing the at least one task.

27. The method of claim 26, further comprising receiving, via the input device, data indicative of a maintenance package corresponding to the time interval.

28. The method of claim 27, further comprising generating a report comprising data indicative the at least one task.

29. A reliability centered maintenance system, comprising:
a graphical user interface comprising selectable input boxes for receiving data indicative of an on-condition task, a restoration task, a replacement task, a combination of tasks, an operational check, and a failure finding task; and
logic configured to receive data indicative of a default strategy for addressing an identified failure mode if each of the selectable input boxes are answered affirmatively.

30. A reliability centered maintenance system, comprising:
a graphical user interface comprising a selectable input box corresponding to an operational check that when selected indicates that a displayed failure mode causes a failure condition that can be inspected before, during, or after operation;
logic configured to receive data indicative of the failure condition and indicative of an operational check default strategy for addressing the failure condition.

31. The system of claim 30, wherein the graphical user interface further comprises a default strategy menu comprising input boxes for technical publications, an engineering change, an operating procedure, training, or other miscellaneous default strategies.

32. A reliability centered maintenance system, comprising:
memory for storing data indicative of a plurality of failure modes;
a graphical user interface comprising a text box for exhibiting data indicative of at least one of the failure modes and a selectable copy button; and
logic configured to display a window comprising a listing of the plurality of failure modes when the selectable copy button is selected, the logic further configured to copy data from the displayed window to the graphical user interface in response to a user input.

33. A reliability centered maintenance system, comprising:
memory for storing data indicative of a plurality of failure modes and failure mode time intervals indexed via a plurality of failure mode identifiers; logic configured to display a portion of the plurality of failure modes, failure mode times intervals, and associated failure mode identifiers, the logic further configured to receive data indicative of an area inspection, a synchronized time interval, and a maintenance package corresponding to the portion of failure modes displayed.

34. A reliability centered maintenance method, comprising:
identifying a scope of an analysis;
generating an operating context related to the scope of analysis;
identifying functions, functional failures, failure modes, and failure effects related to the operating context;
analyzing each failure mode identified in the identifying step; and
assign at least one default strategy to at least one failure mode for addressing the failure mode.

35. The method of claim 34, further comprising generating a plurality of reports related to the analyzed failure mode.

36. The method of claim 35, wherein at least one of the reports is an audit report to be used in auditing the failure modes identified.
